(19) United States
(12) Patent Application Publication
(10) Pub. No.: US 2024/0249132 A1
(43) Pub. Date: Jul. 25, 2024

(54) MULTI-RESISTOR UNIT CELL CONFIGURATION FOR IMPEMENTAITON IN ANALOG NEUROMORPHIC CIRCUITS

(71) Applicant: Brisk Computing LLC, Centerville, OH (US)

(72) Inventors: Chris Yakopcic, Dayton, OH (US); Tarek M. Taha, Centerville, OH (US)

(21) Appl. No.: 18/420,742

(22) Filed: Jan. 23, 2024

Related U.S. Application Data
(60) Provisional application No. 63/440,458, filed on Jan. 23, 2023.

(51) Int. Cl. G06N 3/065; G06N 3/049

(52) U.S. Cl. CPC G06N 3/065; G06N 3/049

(57) ABSTRACT

An analog neuromorphic circuit is discloses input voltages applied to inputs of the analog neuromorphic circuit. Resistor banks that include fixed resistors provide a variable resistance to each input voltage. The variable resistance of each resistor bank is based on an overall resistance value of fixed resistors included in each resistor bank. A controller adjusts the variable resistance of each resistor bank by adjusting the overall resistance value of the fixed resistors to obtain a functionality of the analog neuromorphic circuit. The overall resistance value of each resistor bank is generated from a fixed resistance value of each fixed resistor relative to each other as included in the resistor bank. The controller executes the functionality of the analog neuromorphic circuit from the input voltages multiplied in parallel with corresponding currents of the input voltages added in parallel and the adjusted variable resistance of each resistor bank.

### CROSS-REFERENCE TO RELATED APPLICATIONS

The present application is a U.S. Nonprovisional Application of U.S. Provisional Application Ser. No. 63/440,458 filed Jan. 23, 2023, the disclosure of which is incorporated by reference in its entirety.

### FIELD OF THE INVENTION

This invention relates to neural networks, and more particularly, to systems and methods for implementing variable resistors in an analog neuromorphic circuit.

### BACKGROUND OF THE INVENTION

Traditional computing systems use conventional microprocessor technology in that operations are performed in chronological order such that each operation is completed before the subsequent operation is initiated. The operations are not performed simultaneously. For example, an addition operation is completed before the subsequent multiplication operation is initiated. The chronological order of operation execution limits the performance of conventional microprocessor technology. Conventional microprocessor design is limited in how small the microprocessors can be designed, the amount of power that the microprocessors consume, as well as the speed in which the microprocessors execute operations in chronological order. Thus, conventional microprocessor technology is proving insufficient in applications that require significant computational efficiency, such as in image recognition.

It is becoming common wisdom to use conventional neuromorphic computing networks which are laid out in a similar fashion as the human brain. Hubs of computing power are designed to function as a neuron in the human brain where different layers of neurons are coupled to other layers of neurons. This coupling of neurons enables the neuromorphic computing network to execute multiple operations simultaneously. Therefore, the neuromorphic computing network has exponentially more computational efficiency than traditional computing systems.

Conventional neuromorphic computing networks are implemented in large scale computer clusters which include computers that are physically large in order to attain the computational efficiency necessary to execute applications such as image recognition. For example, applications of these large scale computer clusters include rows and rows of physically large servers that may attain the computational efficiency necessary to execute image recognition when coupled together to form a conventional neuromorphic computing network. Such large scale computer clusters not only take up a significant amount of physical space but also require significant amounts of power to operate.

The significant amount of physical space and power required to operate conventional neuromorphic computing networks severely limits the types of applications for which conventional neuromorphic computing networks may be implemented. For example, industries such as biomedical, military, robotics, and mobile devices are industries that cannot implement conventional neuromorphic computing networks due to the significant space limitations in such industries as well as the power limitations. Therefore, an effective means to decrease the space and the power required by conventional neuromorphic computing is needed.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention. Additionally, the left most digit(s) of a reference number identifies the drawing in which the reference number first appears.

FIG. 1 is a schematic illustration of an exemplary analog neuromorphic processing device that simultaneously executes several computing operations in parallel in accordance with an embodiment of the disclosure;

FIG. 2 is a schematic illustration of an exemplary analog neuromorphic circuit that simultaneously executes several computing operations in parallel in accordance with an embodiment of the disclosure;

FIG. 3 is a schematic illustration of an exemplary neural network configuration that the analog neuromorphic circuit of FIG. 2 may be implemented and scaled in accordance with an embodiment of the disclosure;

FIG. 4 is a schematic illustration of a detailed analog neuromorphic configuration in accordance with an embodiment of the disclosure;

FIG. 5 is a schematic illustration of a programmable resistor configuration in accordance with an embodiment of the disclosure;

FIG. 6 is a schematic illustration of a programmable resistor configuration in accordance with an embodiment of the disclosure;

FIG. 7 is a schematic illustration of a detailed analog neuromorphic configuration in accordance with an embodiment of the disclosure;

FIG. 8 is a schematic illustration of a multi-bit programmable unit cell design in accordance with an embodiment of the disclosure;

FIG. 9 is a schematic illustration of an unit cell neural network configuration in accordance with an embodiment of the disclosure;

an unit cell neural network configuration 900 is shown

FIG. 10 is a schematic illustration of an example neural network hardware architecture configuration in accordance with an embodiment of the disclosure;

FIG. 11 is a schematic illustration of a neural network hardware architecture configuration that depicts how one of the layers in convolutional neural network may be reduced;

FIG. 12 is a schematic illustration of a training analog neuromorphic configuration 1200 in accordance with an embodiment of the disclosure.

### DETAILED DESCRIPTION

The following Detailed Description refers to accompanying drawings to illustrate exemplary embodiments consistent with the present disclosure. References in the Detailed Description to “one embodiment,” “an embodiment,” “an exemplary embodiment,” etc., indicate that the exemplary embodiment described can include a particular feature, structure, or characteristic, but every exemplary embodiment does not necessarily include the particular feature, structure, or characteristic. Moreover, such phrases are not necessarily referring to the same embodiment. Further, when a particular feature, structure, or characteristic is described in connection with an embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other embodiments are possible, and modifications can be made to exemplary embodiments within the scope of the present disclosure. Therefore, the Detailed Description is not meant to limit the present disclosure. Rather, the scope of the present disclosure is defined only in accordance with the following claims and their equivalents.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed may be considered a module, and the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner

The following Detailed Description of the exemplary embodiments will so fully reveal the general nature of the present disclosure that others can, by applying knowledge of those skilled in the relevant art(s), readily modify and/or adapt for various applications such exemplary embodiments, without undue experimentation, without departing from the scope of the present disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not limitation, such that the terminology or phraseology of the present specification is to be interpreted by those skilled in relevant art(s) in light of the teachings herein.

The present invention creates an analog neuromorphic computing network by implementing variable resistors. A variable resistor that may change resistance level based when pulsed. For example, a variable resistor may include a unit cell which includes a configuration of a resistor and a transistor in which the resistance of the may be adjusted based on the pulsing of the transistor thereby acting as a variable resistor. A combination of variable resistors may generate output values that may be positive and/or negative. Such characteristics of the variable resistor enables neuromorphic computing to be shrunk down from implementing large computers to a circuit that can be fabricated onto a chip while requiring minimal power due to the analog characteristics of the variable resistor.

The variable resistors may be positioned in a crossbar configuration in that each variable resistor is positioned at an intersection of a plurality of horizontal wires and a plurality of vertical wires forming a wire grid. An input voltage may be applied to each horizontal wire. Each variable resistor may apply a resistance to each input voltage so that each input voltage is multiplied by each resistance. The positioning of each variable resistor at each intersection of the wire grid enables the multiplying of each input voltage by the resistance of each variable resistor to be done in parallel. The multiplication in parallel enables multiple multiplication operations to be executed simultaneously. Each current relative to each horizontal wire may then be added to generate an accumulative current that is conducted by each vertical wire. The addition of each current to generate the accumulative currents is also done in parallel due to the positioning of the variable resistors at each intersection of the wire grid. The addition in parallel also enables multiple addition operations to be executed simultaneously. The simultaneous execution of addition and multiplication operations in an analog circuit generates significantly more computational efficiency than conventional microprocessors while implementing significantly less power than conventional microprocessors.

The terms “horizontal” and “vertical” are used herein for ease of discussion to refer to one example of the invention. It should be understood however that such orientation is not required, nor is a perpendicular intersection required. It is sufficient that a plurality of parallel wires intersects a pair of parallel wires to form a crossbar or grid pattern having two wires for adding current and two or more wires for inputting voltages, with a resistive memory positioned at each intersection for multiplication. The intersections may occur at right angles (orthogonal crossing lines) or non-right angles. It may be understood, however, that the orthogonal arrangement provides the simplest means for scaling the circuit to include additional neurons and/or layers of neurons. Further, it may be understood than an orientation having horizontal rows and/or vertical columns is also simpler for scaling purposes and is a matter of the point of reference, and should not be considered limiting. Thus, any grid configuration orientation is contemplated.

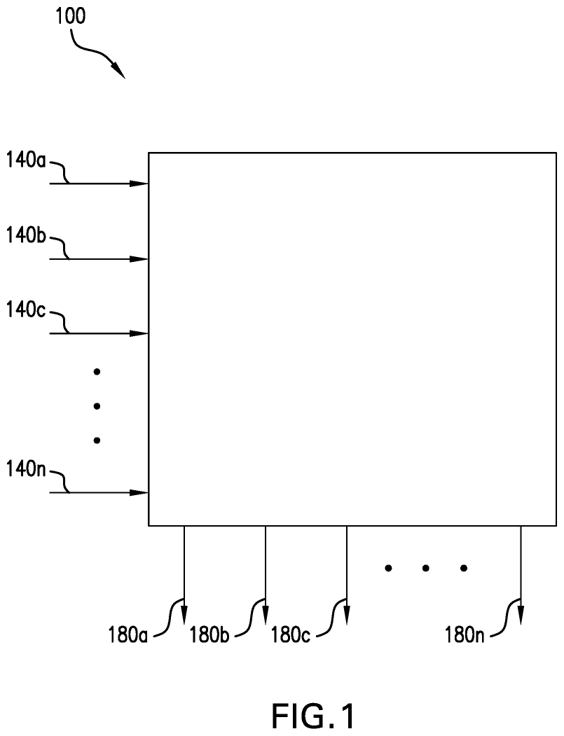

Referring to FIG. 1, an analog neuromorphic processing device 100 simultaneously executes several computing operations in parallel. The analog neuromorphic processing device 100 includes a plurality of input voltages 140(a-n) that are applied to a plurality of respective inputs of the analog neuromorphic processing device 100 and the analog neuromorphic processing device 100 then generates a plurality of output signals 180(a-n).

The analog neuromorphic processing device 100 may include a plurality of variable resistors (not shown) that have variable resistance characteristics that may be exercised not only with low levels of power. The variable resistance characteristics of the variable resistors enable the variable resistors to act as memory while maintaining significantly low power requirements compared to conventional microprocessors. The variable resistance capabilities of the variable resistors coupled enable the variable resistors to be configured so that the analog neuromorphic processing device 100 has significant computational efficiency while maintaining the size of the analog neuromorphic processing device 100 to a chip that may easily be positioned on a circuit board.

For example, the variable resistors may include but are not limited to a unit cell that includes one or more resistors and a transistor. Each resistor has a corresponding fixed resistance. However, the resistance value of the unit cell may be varied by activating and/or deactivating each fixed resistor in the unit cell by the transistor thereby adjusting the resistance of the unit cell. As a result, the unit cell may operate as a variable resistor. The physics of the variable resistor, such as the unit cell with the fixed resistor and transistor configuration, require significantly low power and occupy little space so that the variable resistors may be configured in the analog neuromorphic processing device 100 to generate significant computational efficiency from a small chip.

The plurality of input voltages 140(a-n), where n is an integer greater than or equal to one, may be applied to corresponding inputs of the analog neuromorphic processing device 100 to exercise the variable resistance characteristics of the variable resistors. The input voltages 140(a-n) may be applied at a voltage level and for a time period that is sufficient to exercise the variable resistance characteristics of the variable resistors. The input voltages 140(a-n) may vary and/or be substantially similar depending on the types of variable resistance characteristics that are to be exercised by each of the variable resistors.

The variable resistors may be arranged in the analog neuromorphic processing device 100 such that the variable resistors may simultaneously execute multiple addition and multiplication operations in parallel in response to the input voltages 140(a-n) being applied to the inputs of the analog neuromorphic processing device 100. The variable resistance characteristics of the variable resistors as well as their nano-scale size enables a significant amount variable resistors to be arranged so that the input voltages 140(a-n) trigger responses in the variable resistors that are then propagated throughout the analog neuromorphic processing device 100 that results in simultaneous multiplication and addition operations that are executed in parallel.

The simultaneous multiplication and addition operations executed in parallel exponentially increases the efficiency of analog neuromorphic processing device 100 while limiting the power required to obtain such computation capabilities to the input voltages 140(a-n). The variable resistors are passive devices so that the simultaneous multiplication and addition operations executed in parallel are performed in the analog domain, which also exponentially decreases the required power. For example, the analog neuromorphic processing device 100 may have significantly more computational efficiency than traditional microprocessor devices, and may be smaller than traditional microprocessor chips while reducing power in a range from 1,000 times to 1,000,000 times that of traditional microprocessors.

The variable resistors may also be arranged such that the simultaneous execution of the multiplication and addition operations in parallel may be configured as a single computation hub that constitutes a single neuron in a neural network. The variable resistance characteristics of the variable resistors further enable the arrangement of variable resistors to be scaled with other arrangements of variable resistors so that the single neuron may be scaled into a neural network including multiple neurons. The scaling of a single neuron into multiple neurons exponentially further increases the computational efficiency of the resulting neural network. In addition, the multiple neurons may be scaled into several layers of neurons that further exponentially increases the computational efficiency of the neural network. The scaling of the variable resistors into additional neurons may be done within the analog neuromorphic processing device 100 such as within a single chip. However, the analog neuromorphic processing device 100 may also be scaled with other analog neuromorphic circuits contained in other chips to exponentially increase the computational efficiency of the resulting neural network.

As a result, the analog neuromorphic processing device 100 may be configured into a neural network that has the capability of executing applications with significant computational efficiency, such as image recognition. For example, the output signals 180(a-n), where n is an integer greater than or equal to one, may generate signals that correctly identify an image. The analog neuromorphic processing device 100 may also have the learning capability as will be discussed in further detail below so that analog neuromorphic circuits may successfully execute learning algorithms.

The analog neuromorphic processing device 100 implemented as a single neuron and/or multiple neurons in a neural network and/or configured with other similar analog neuromorphic processing device 100 may have significant advantages in traditional computing platforms that require significant computational efficiency with limited power resources and space resources. For example, such traditional computing platforms may include but are not limited to Fast Fourier Transform (FFT) applications, Joint Photographic Experts Group (JPEG) image applications, and/or root mean square (RMS) applications. The implementation of low power neural networks that have a limited physical footprint may also enable this type of computational efficiency to be utilized in many systems that have traditionally not been able to experience such computational efficiency due to the high power consumption and large physical footprint of conventional computing systems. Such systems may include but are not limited to military and civilian applications in security (image recognition), robotics (navigation and environment recognition), and/or medical applications (artificial limbs and portable electronics).

The layering of the analog neuromorphic processing device 100 with other similar analog neuromorphic circuits may enable complex computations to be executed. The compactness of the resistive memory crossbar configurations enables fabrication of chips with a high synaptic density in that each chip may have an increased amount of neurons that are fitted onto the chip. The passive characteristics of the resistive memories eliminate the need for software code which increases the security of the analog neuromorphic processing device 100.

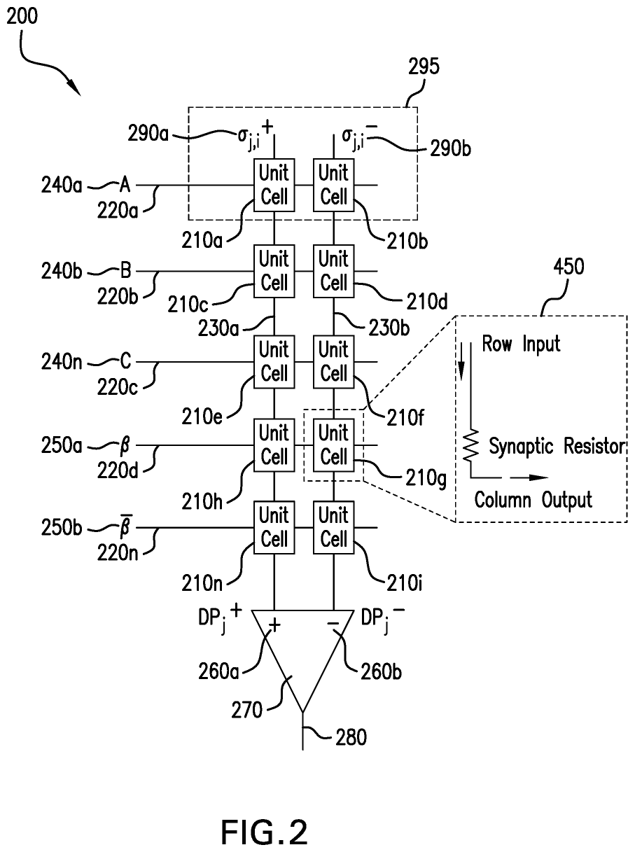

Referring to FIG. 2, an analog neuromorphic circuit 200 simultaneously executes several computing operations in parallel. The analog neuromorphic circuit 200 includes a plurality of variable resistors 210(a-n) where n is an integer equal to or greater than four, a plurality of horizontal wires 220(a-n) where n is an integer equal to or greater than two, a pair of vertical wires 230(a-b), a plurality of input voltages 240(a-n) where n is an integer equal to or greater than two, a pair of bias voltage connections 250(a-b), a first and second input of a comparator 260(a-b), a comparator 270, an output of the comparator 280, a pair of weights 290(a-b), and a combined weight 295. The analog neuromorphic circuit 200 shares many similar features with the analog neuromorphic processing device 100; therefore, only the differences between the analog neuromorphic circuit 200 and the analog neuromorphic processing device 100 are to be discussed in further detail.

The analog neuromorphic circuit 200 may be representative of a single neuron of a neural network. The analog neuromorphic circuit 200 has the capability to be scaled to interact with several other analog neuromorphic circuits so that multiple neurons may be implemented in the neural network as well as creating multiple layers of neurons in the neural network. Such a scaling capability to include not only multiple neurons but also multiple layers of neurons significantly magnifies the computational efficiency of the neural network, as will be discussed in further detail below.

The variable resistors 210(a-n) may be laid out in a crossbar configuration that includes a high density wire grid. The crossbar configuration enables the variable resistors 210(a-n) to be tightly packed together in the wire grid as will be discussed in further detail below. The tightly packed variable resistors 210(a-n) provides a high density of variable resistors 210(a-n) in a small surface area of a chip such that numerous analog neuromorphic circuits may be positioned in a neural network on a chip while occupying little space. The crossbar configuration also enables the variable resistors 210(a-n) to be positioned so that the analog neuromorphic circuit 200 may execute multiple addition and multiplication operations in parallel in the analog domain The numerous neuromorphic circuits may then be positioned in the neural network so that the multiple addition and multiplication operations that are executed in parallel may be scaled significantly, thus exponentially increasing the computational efficiency. The variable resistors 210(a-n) are passive devices so that the multiple addition and multiplication operations executed in parallel are done in the analog domain, which also exponentially decreases the required power.

In an embodiment, the horizontal wires 220(a-n) may be positioned to intersect with the vertical wires 230(a-b) to form a wire grid. In an embodiment, the horizontal wires 220(a-n) may be positioned orthogonal to the vertical wires 230(a-b). Each of the variable resistors 210(a-n) may be positioned at an intersection of the wire grid. For example variable resistor 210a is positioned at the intersection of horizontal wire 220a and the vertical wire 230a; the variable resistor 210b is positioned at the intersection of horizontal wire 220b and the vertical wire 230b and so on. The positioning of the horizontal wires 220(a-n) and the vertical wires 230(a-b) to form a wire grid and the positioning of each of the variable resistors 210(a-n) at each intersection of the wire grid may form the crossbar configuration.

Input voltages 240(a-n) may be applied to each of the respective horizontal wires 220(a-c). In FIG. 1, the input voltage 240a is represented by “A”, the input voltage 240b is represented by “B”, and the input voltage 240n is represented by “C”. For example, the input voltage 240a may be applied to the horizontal wire 220a, the input voltage 240b may be applied to the horizontal wire 220b, and the input voltage 240c may be applied to the horizontal wire 220c. As each of the input voltages 240(a-n) is applied to each of the respective horizontal wires 220(a-c), the resistance of each of the respective resistive memories 210(a-f) is multiplied with each of the respective input voltages 240(a-n) to generate a current that is then conducted by each of the respective vertical wires 230(a-b). The crossbar configuration then enables the multiplication of each of the respective input voltages 240(a-n) with the resistance of each of the variable resistors 210(a-f) in parallel so that each of the multiplications is executed simultaneously. The execution of multiple multiplication operations in parallel results in significant computational efficiency as compared to traditional microprocessors that execute each multiplication operation in a chronological order in that the current multiplication operation is completed before the subsequent multiplication operation is executed.

For example, the input voltage 240a is applied to the horizontal wire 220a. The resistance of the variable resistor 210a is multiplied with the input voltage 240a to generate a current that is then conducted by the vertical wire 130a that intersects the horizontal wire 220a at the variable resistor 210a. The resistance of the variable resistor 210b is multiplied with the input voltage 240a to generate a current that is then conducted by the vertical wire 230b that intersects the horizontal wire 220a at the variable resistor 210b. The crossbar configuration then enables the input voltage 240a to not only be multiplied by the resistance of the variable resistor 210a to generate the current conducted by the vertical wire 230a but also the multiplication of the input voltage 140a by the resistance of the variable resistor 210b in parallel to generate current conducted by the vertical wire 230b. The multiplication of the input voltages 240b to 240n happens in a similar fashion simultaneously with the multiplication of the input voltage 240a.

As each of the currents relative to each of the horizontal wires 220(a-c) are conducted by each of the vertical wires 230(a-b), those currents are then added to generate accumulative currents that are conducted by each of the respective vertical wires 230(a-b). For example and as noted above, the application of the input voltage 240a to the horizontal wire 220a is multiplied by the resistance of the variable resistor 210a to generate a current that is then conducted by the vertical wire 230a. The application of the input voltage 240b to the horizontal wire 220b is multiplied by the resistance of the variable resistor 210c to generate a current that is also conducted by the vertical wire 230a. The current generated from the input voltage 240a being applied to the horizontal wire 220a is then added to the current generated from the input voltage 240b being applied to the horizontal wire 220b. The addition of the current generated from the input voltage 240n being applied to the horizontal wire 220c that is multiplied by the resistance of the resistive memory 210e is also added to the currents generated by the input voltage 240a being applied to the horizontal wire 220a and the input voltage 240b being applied to the horizontal wire 220b to generate an accumulative current.

The adding of currents conducted by the vertical wire 230b is also done in a similar manner The crossbar configuration enables the adding of the currents conducted by the vertical wire 230a to be done in parallel with the adding of the currents conducted by the vertical wire 230b so that the addition operations are done simultaneously. The crossbar configuration also enables the adding of the currents to be done simultaneously with the multiplication of each of the input voltages 240(a-n) with the resistance of each of the respective variable resistors 210(a-f). The simultaneous execution of multiple addition operations as well as multiple multiplication operations results in significant computational efficiency as compared to traditional microprocessors that execute each multiplication operation and then each addition operation in a chronological order in that the current multiplication operation is completed before the subsequent addition operation is executed.

As a result, the analog neuromorphic circuits that are configured into a neural network have the capability of executing applications requiring significant computation power, such as image recognition. The analog neuromorphic circuits also have learning capability as will be discussed in further detail below so that the analog neuromorphic circuits may successfully execute learning algorithms.

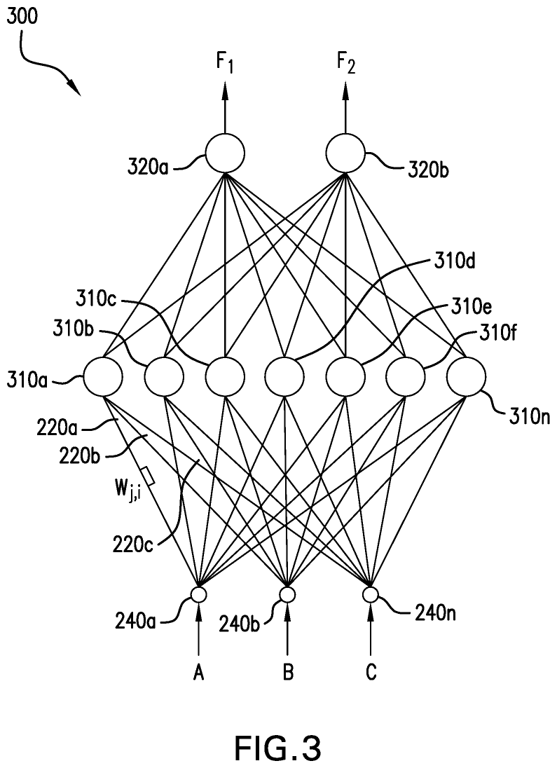

Referring to FIG. 3, in which like reference numerals are used to refer to like parts, neural network configuration 300 that the analog neuromorphic circuit 200 may be implemented and scaled into is shown. The neural network configuration 300 shares many similar features with the analog neuromorphic processing device 100 and the analog neuromorphic circuit 200; therefore, only the differences between the neural network configuration 200 and the analog neuromorphic processing device 100 and the analog neuromorphic circuit 200 are to be discussed in further detail.

The analog neuromorphic circuit 200 may be implemented into the neural network configuration 300. The analog neuromorphic circuit 200 may constitute a single neuron, such as neuron 310a in the neural network configuration 300. As shown in FIG. 3, the input voltage 240a and represented by “A” is applied to the horizontal wire 220a, the input voltage 240b and represented by “B” is applied to the horizontal wire 220b, and the input voltage 240n and represented by “C” is applied to the horizontal wire 220c. The combined weight 295 as shown in FIG. 2 as representative of the combined weight for the input voltage 240a is shown as Wⱼ, i in FIG. 3. Similar combined weights for the input voltage 240b and the input voltage 240n may also be represented in FIG. 3 in a similar fashion. The wire grid, the variable resistors 210(a-n), and the comparator 270 are represented by the neuron 310a. The output 280 of the analog neuromorphic circuit 200 is coupled to additional neurons 320a and 320b.

The analog neuromorphic circuit 200 may then be scaled so that similar circuits may be configured with the analog neuromorphic circuit 200 to constitute additional neurons, such as neurons 310(b-n) where n is an integer greater than or equal to two. Each of the other neurons 310(b-n) includes similar circuit configurations as the analog neuromorphic circuit 200. However, the resistances of the variable resistors associated with each of the other neurons 310(b-n) may differ from the analog neuromorphic circuit 200 so that outputs that differ from the output 280 of the analog neuromorphic circuit 200 may be generated.

Rather than limiting the input voltages 240(a-n) to be applied to a single neuron 310, the input voltages 240(a-n) may also be applied to multiple other neurons 310(b-n) so that each of the additional neurons 310(b-n) also generate outputs that differ from the output 280 generated by the analog neuromorphic circuit 200. The generation of multiple different outputs from the different neurons 310(a-n) exponentially increases the computational efficiency of the neural network configuration 300. As noted above, the analog neuromorphic circuit 200 represented by the neuron 310a operates as a single logic function with the type of logic function being adjustable. The addition of neurons 310(b-n) provides additional logic functions that also have the capability of their logic functions being adjustable so that the computational efficiency of the neural network configuration 300 is significant.

In addition to having several different neurons 310(a-n), the analog neuromorphic circuit 200 may also be scaled to include additional layers of neurons, such as neurons 320(a-b). The scaling of additional layers of neurons also exponentially increases the computational efficiency of the neural network configuration 300 to the extent that the neural network configuration 300 can execute learning algorithms. For example, a neural network configuration with a significant number of input voltages, such as several hundred, that are applied to a significant number of neurons, such as several hundred, that have outputs that are then applied to a significant number of layers of neurons, such as ten to twenty, may be able to execute learning algorithms. The repetitive execution of the learning algorithms by the extensive neural network configuration may result in the neural network configuration eventually attaining automatic image recognition capabilities.

For example, the neural network configuration may eventually output a high voltage value of “F₁” representative of the binary signal “1” and output a low voltage value of “F₂” representative of the binary signal “0” when the neural network configuration recognizes an image of a dog. The neural network configuration may then output a low voltage value of “F₁” representative of the binary signal “0” and output a high voltage value of “F₂” representative of the binary signal “1” when the neural network configuration recognizes an image that is not a dog.

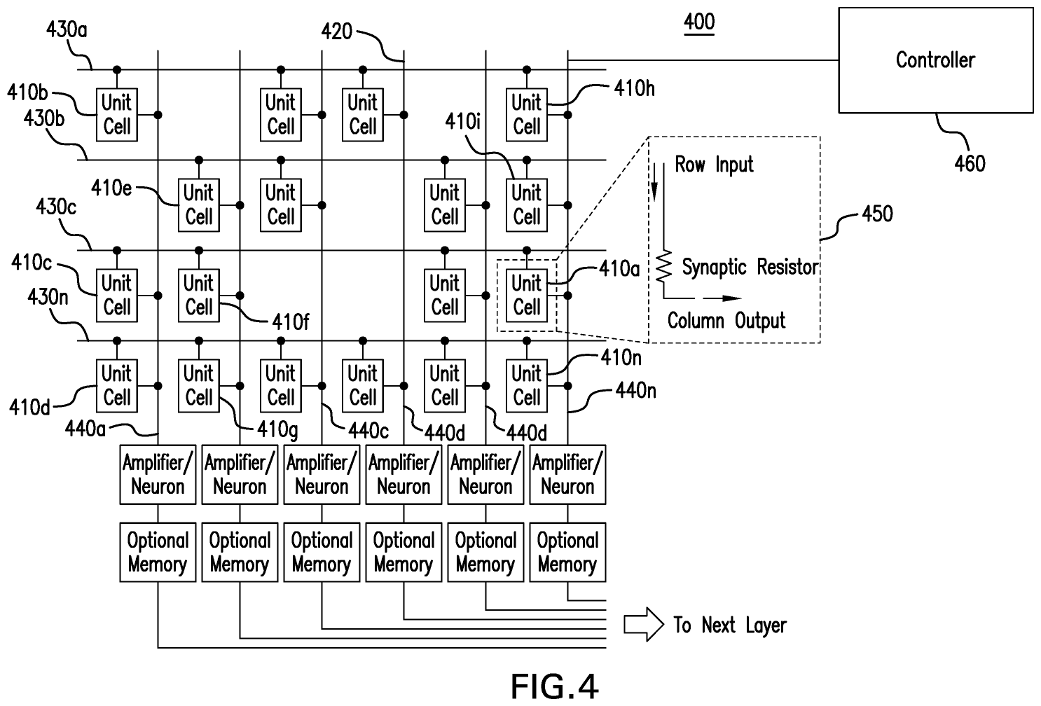

Referring to FIG. 4, in which like reference are used to refer to like parts, a detailed analog neuromorphic configuration 400 is shown. The analog neuromorphic configuration 400 shares many similar features with the analog neuromorphic processing device 100, the analog neuromorphic circuit 200, and the neural network configuration 300; therefore, only the differences between the analog neuromorphic configuration 400 and the analog neuromorphic processing device 100, the analog neuromorphic circuit 200, and the neural network configuration 300 are to be discussed in more detail.

The analog neuromorphic configuration 400 may include a plurality of resistive unit cells 410(a-n), where n is an integer equal or greater than one and a controller 460. Each resistive unit cell 410(a-n) may be positioned at a cross point of the row (horizontal) wires and the column (vertical) wires that form a crossbar layer 420. The positioning of the resistive unit cell 410(a-n) at the cross point of a row and column of the crossbar layer 420 may generate a synaptic weight at the cross point of row and column. As a result, such a synaptic weight is formed at each cross point where a resistive unit cell 410(a-n) is present and the absence of a resistive unit cell 410(a-n) at any cross point may result in no connection to any other cross point thereby resulting in a lack of a synaptic weight at such cross points. The positioning of the resistive unit cell 410(a-n) at any respective cross point and lack thereof, may enable the production of a binary weight layer. A resistive unit cell 410(a-n) that is positioned at a cross point provides a resistance thereby a weight and a lack of a resistive unit cell 410(a-n) positioned at a cross point fails to provide a resistance thereby failing to provide a synaptic weight thereby enabling a binary weight layer for the crossbar layer 420. The implementation of a second crossbar to receive a complement (negative reciprocal) of a plurality of input voltages 430(a-n), where n is an integer that equals the quantity of rows of crossbar layer 420, may enable a synaptic weight to take on any value in the subset of [−1, 0, 1] and may thus provide an efficient neural network system.

The analog neuromorphic configuration 400 may conduct a vector-matrix multiplication where the input voltages 430(a-n) may be applied to the crossbar configuration 420 in a vector format based on the positioning of each resistive unit cell 410(a-n) at the intersection of each corresponding row and column of the crossbar layer 420. The conductance of each resistive unit cell 410(a-n) generated from the resistance value of each resistive unit cell 410(a-n) as applied to the corresponding input voltage 430(a-n) is a weight value such that the weight value of the resistive unit cell 410(a-n) represents a corresponding weight in the weight matrix. Thus, the output current at each column output 440(a-n), where n is an integer equal to or greater than 2, may be a dot product between the input voltages 430(a-n) and a column output 440(a-n) in the matrix of conductance values that corresponds to the weights of each corresponding resistive unit cell 410(a-n). An amplifier may be connected to each column output 440(a-n) to translate the output current at each column output 440(a-n) into an output voltage value that matches an equivalent software network.

Thus, the analog neuromorphic configuration 400 implements a binary weight matrix in which each value in the weigh matrix one of two different values of “0” or “1”. The positioning of the resistive unit cell 410(a-n) at a cross point may represent a “1” value. A synaptic resistor 450 included in each resistive unit cell 410(a-n) may apply a resistance to the corresponding input voltage 420(a-n) that represents a weight thereby generating a conductance that impacts the resulting current that propagates down each column to the corresponding column output 440(a-n). Thus, the presence of the resistive unit cell 410(a-n) at the cross point represents a “1” value in the binary weight matrix. The absence of the resistive unit cell 410(a-n) at a cross point fails to have a synaptic resistor 450 that may apply a resistance to the corresponding input voltage 420(a-n) that represents a weight thereby failing to generate a conductance that impacts the resulting current that propagates down each column to the corresponding column output 440(a-n). Thus, the lack of the resistive cell 410(a-n) at a cross point represents a “0” value in the binary weight matrix as that cross point may never contribute any current to resulting column output 440(a-n).

In an embodiment, the analog neuromorphic configuration 400 may be a non-programmable and/or semi-programmable system based on the cross points that are left empty from having a resistive unit cell 410(a-n) positioned at such empty cross points. In doing so, the footprint as well as the power requirements may be reduced based on the reduction in resistive unit cells 410(a-n) not positioned at every cross point. However, the analog neuromorphic configuration 400 may still conduct vector-matrix multiplication as discussed above based on the positioning of the resistive unit cells 410(a-n) at different cross points but not requiring such positioning of resistive unit cells 410(a-n) at every cross point.

For example, the analog neuromorphic configuration 400 may still execute convolution and/or other operations in which a sparse matrix may be programmed into the analog neuromorphic configuration 400. In such an example, a 20×20 input image may have a combination of 3×3 convolution filters in which the filter values may change but the locations of the filter values do not change locations. In doing so, the resistances generated by resistive unit cells 410(a-n) may be adjusted to correspond to the changing filter values and thus be programmable. However, the location of such filter values may not change and may remain fixed as there are cross points included in the analog neuromorphic configuration 400 that fail to have resistive unit cell 410(a-n) positioned at such cross points. As a result, the location of such filter values may remain fixed to ensure such filter values are positioned to where a corresponding resistive unit cell 410(a-n) is positioned. Thus, the analog neuromorphic configuration 400 may implement a static convolution network that may have the filter values programmable based on the positions of the matrix that is mapped to the analog neuromorphic configuration 400 but such positons would be static based on the positions of each resistive unit cell 410(a-n) relative to cross points that do not have resistive unit cells 410(a-n) resulting in a semi-programmable configuration.

As discussed above, the resistive unit cells 410(a-n) may include a synaptic resistor 450 may apply a resistance to the corresponding input voltage 420(a-n) that represents a weight thereby generating a conductance that impacts the resulting current that propagates down each column to the corresponding column output 440(a-n). In doing so, the weight may generated by the resistance of the synaptic resistor 450 may impact the neural capabilities of the analog neuromorphic configuration 400 in that the weight generated by the resistance of the synaptic resistor 450 in combination with each of the weights generated by the resistance of the resistive unit cells 410(a-n) determines the output voltage values of the crossbar configuration 420. Such output voltage values of the crossbar layer 420 in combination with each other crossbar layer included in the analog neuromorphic configuration 100 then represent the recognition of the neural network represented by the analog neuromorphic configuration 400.

For example, the analog neuromorphic configuration 400 may be configured to recognize an image of a cat. However, initially, the analog neuromorphic configuration may incorrectly identify the image of the cat as a dog. In doing so, the weight generated by the resistance of the synaptic resistor 450 of each resistive unit cell 410(a-n) resulted in the analog neuromorphic configuration 400 incorrectly identifying the image of the cat as a dog. In order to correct the identification of the analog neuromorphic configuration 400 to correctly identify the image of the cat, each weight generated by the resistance of synaptic resistor 450 of each resistive unit cell 410(a-n) may be adjusted in iterations until the output voltage values of the crossbar layer 420 in combination with each other crossbar layer included in the analog neuromorphic configuration 100 correctly represent the identification of the image as the cat thereby training the analog neuromorphic configuration 400.

The iterative adjustment of each generated by the resistance of the synaptic resistor 450 of each resistive unit cell 410(a-n) may be executed by adjusting the resistance value of the synaptic resistor 450. Such adjustment of the resistance value of the synaptic resistor of each of the numerous resistive unit cells 410(a-n) positioned in the analog neuromorphic configuration 400 throughout thousands of iterations until the analog neuromorphic configuration 400 is adequately trained may be significantly enhanced with the implementation of variable resistors. Implementing variable resistors as the synaptic resistor 450 of each resistive unit cell 410(a-n) may enable the resistance value of the synaptic resistor 450 to be easily adjusted iteratively in order to generate the appropriate weight when in combination with the iterative adjustment of the resistance value of the numerous other resistive unit cells 410(a-n) to generate the appropriate weights to adequately train the analog neuromorphic configuration 400. Each variable resistor may have different resistance states thereby enabling such variable resistors to represent different types of weight values in the neural network with the different resistance states.

For example, the synaptic resistor 450 of the resistive unit cells 410(a-n) may include a resistive memories that have variable resistance characteristics that may be exercised not only with low levels of power but may also exercise those variable resistance characteristics after power applied to the resistive memories has been terminated. The variable resistance characteristics of the resistive memories enable the resistive memories to act as memory while maintaining significantly low power requirements compared to conventional microprocessors. The resistive memories are also of nano-scale sizes that enable a significant amount of resistive memories to be configured within the analog neuromorphic configuration 400 while still maintaining significantly low power level requirements. The variable resistance capabilities of the resistive memories coupled with the nano-scale size of the resistive memories enable the resistive memories to be configured so that the analog neuromorphic configuration 400 has significant computational efficiency while maintaining the size of the analog neuromorphic configuration 400 to a chip that may easily be positioned on a circuit board.

For example, the resistive memories may include but are not limited to memristors that are nano-scale variable resistance devices with a significantly large variable resistance range. The physics of the resistive memories, such as memristors, require significantly low power and occupy little space so that the resistive memories may be configured in the analog neuromorphic configuration 400 to generate significant computational efficiency from a small chip.

However, the fabrication of a memristor chip currently is extremely expensive and requires an extreme investment simply to fabricate the memristor chip such that the fabrication of the memristor chip may then be scalable. As a result, the fabrication of a memristor chip may simply not be feasible with the current state of the technology due such an extreme investment required to fabricate a memristor chip for scalability. Further, memristors may have a limited number of writes during training. Although the ease in adjusting the variable resistance of memristors in training is a significant advantage of memristors, such memristors may have a limited number of writes during training For example, a memristor may have a limit of one million writes before the memristor may no longer be able to adjust the variable resistance of the memristor after reaching the limit of one million writes. Some training applications may require a few hundred thousand writes per second. In such training applications, the memristors may saturate write operations in a few months.

Rather than incorporate memristors as variable resistors in analog neuromorphic configurations, existing resistors that are available in commercial fabrication may be implemented in a manner to mimic the variable resistance capabilities of memristors. Such existing resistors may be fixed resistors in that such resistors may have fixed resistance values that may be static in that such fixed resistance values may not be able to be dynamically varied in a manner as memristors. However, such fixed resistors may be implemented in a manner such that such fixed resistors with fixed resistance values may operate as variable resistors thereby enabling the learning and training of analog neuromorphic configurations.

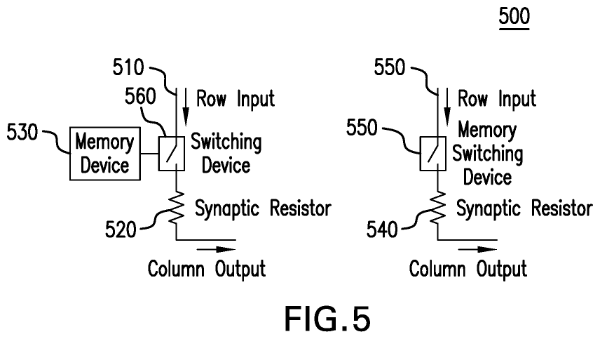

FIG. 5, in which like reference numerals are used to refer to like parts, a programmable resistor configuration 500 is shown. The programmable resistor configuration 500 depicts two different example embodiments of programmable resistor unit cells. A first programmable resistor unit cell 510 includes a synaptic resistor 520 in which a switching device 520 is pulsed by a memory device 530 to activate and/or deactivate the synaptic resistor 520. A second programmable resistor unit cell 550 includes a synaptic resistor 540 in which a combined memory switching device 550 activates and/or deactivates the synaptic resistor 540.

The synaptic resistor 520 and 540 may be fixed resistors in which the synaptic resistor 520 and 540 have fixed resistance values that may not be varied. However, the fixed resistance value of the fixed resistor 520 and 540 may be significantly increased when incorporated with the switching device 520 and 550. The memory device 530 and 550 may pulse the switching device 560 and 550 such that the switching device closes thereby activating the synaptic resistor 520 and 540 such that the fixed resistance values of the synaptic resistor 520 and 540 are also activated. The memory device 530 and 550 may also pulse the switching device 520 and 550 such that the switching device 560 and 550 opens thereby deactivating the synaptic resistor 520 and 540 such that the fixed resistance values of the synaptic resistor 520 and 540 are also deactivated.

In doing so, the programmable resistor unit cell 510 and 550 may be incorporated into an analog neuromorphic configuration and positioned at each cross point of the analog neuromorphic configuration. The programmable resistor unit cell 510 and 550 may then be activated when the fixed resistance value is required to apply such fixed resistance as a weight to the input voltage thereby generating a conductance to influence the current that then propagates to the column output and ultimately is converted to an output voltage. The programmable resistor unit cell 550 may then be activated when the fixed resistance value is not required to apply such fixed resistance as a weight to the input voltage thereby not generating a conductance to influence the current that then propagates to the column output and is ultimate converted to an output voltage.

As a result, the programmable resistor unit cells 510 and 550 may be programmed such that the memory device 530 and 550 may pulse the switching device 560 and 550 to activate and/or deactivate the synaptic resistor 520 and 540 thereby adjusting the weight provided by the programmable resistor unit cells 510 and 550 by activating and/or deactivating the fixed resistance of the synaptic resistor 520 and 540. Such adjustment may enable the programmable resistor unit cells 510 to 550 when in combination with numerous other programmable resistor unit cells 510 to 550 to be iteratively trained. The combination of programmable resistor unit cells 510 and 550 that may be activated and/or deactivated thereby applying such combination of weights or lack thereof may be determined such that the resulting output voltages from the currents influenced by the conductance generated by such combination of weights may ultimately result in the correct recognition by the neural network represented by the analog neuromorphic configuration.

Rather than implement memristors that may require a significant investment in fabrication, the programmable resistor unit cells 510 and 550 may instead implement existing fixed resistors currently in fabrication but may do so in manner that transforms the fixed resistors into variable resistors to mimic the variable resistance characteristics of memristors. Such programmable resistor unit cells 510 and 550 are also predictable in their behavior as the fixed resistance values of the fixed resistors are static in that the fixed resistance value is either activated and/or deactivated based on the pulsing of the switching device 560 and 550 thereby increasing the ability to control the overall training of the analog neuromorphic circuit. The programmable resistor unit cells 510 and 550 also provide uniformity across the chip due to currently in fabrication. Further, programmable resistor unit cells 510 and 550 do not have a write limit as the programmable resistor unit cells may be implemented in SRAM.

The programmable resistor unit cells 510 and 550 may contain one or more resistors, along with memory elements 530, 550 and switches 560, 550 to control if each synaptic resistor 520, 540 is active during synaptic computations. This may allow reprogramming of the network based on a new set of trained weights without any sort of irreversible programming hardware development processes. The switching device 530, 550 must be closed for the synaptic resistor 520, 540 to contribute to synaptic computation, and the switch 530, 550 is controlled by the memory element 530, 550. Multiple copies of the programmable resistor unit cells 510, 550 may be placed in parallel to develop a more complex programmable resistance that would all contribute to the weight value programmed at a single cross point in a crossbar configuration. The memory element 530 and switching device 560 may be separate devices, such as in programmable resistor unit cell 510, where memory element 530 and switching device could be an SRAM cell and an analog pass gate. Alternatively, memory switching device 550 may be a single device, such as in programmable resistor unit cell 550, where memory switching device may be a floating gate transistor or an RRAM device.

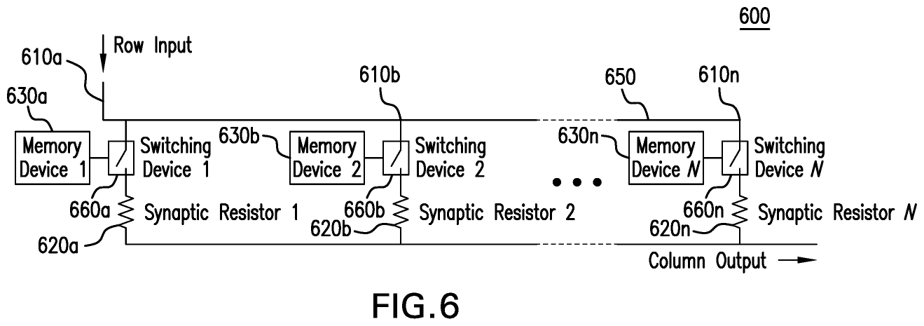

FIG. 6, in which like reference numerals are used to refer to like parts, a programmable resistor configuration 600 is shown. The programmable resistor configuration 600 depicts a resistor bank 650 in which the resistor bank 650 includes a plurality of resistor unit cells 610(a-n), where n is an integer equal to or greater than two. Each resistor unit cells 610(a-n) is positioned in parallel within the resistor bank 650. Each resistor unit cell 610(a-n) is a resistor unit cell as discussed above with regard to the programmable resistor unit cell 510 in which each resistor unit cell 610(a-n) includes a memory device 630(a-n), where n is an integer that equals the quantity of resister unit cells 610(a-n), a switching device 660(a-n), where n is an integer that equals the quantity of resistor unit cells 610(a-n), and synaptic resistor 620(a-n), where n is an integer equal to the quantity of resistor unit cells 610(a-n). The programmable resistor configuration 600 shares many similar features with the programmable resistor configuration 500; therefore, only the differences between the programmable resistor configuration 600 and the programmable resistor configuration 500 are to be discussed in more detail.

Each resistor unit cell 610(a-n) included in the resistor bank 650 may operate in a similar manner as discussed above with regard the programmable resistor unit cell 510. As discussed above, the single synaptic resistor 520 of the programmable resistor unit cell 510 may be activated and/or deactivate thereby activating and/or deactivating the fixed resistance as the weight applied to the conductance to influence the current that propagates to the column outputs. In doing so, the weight applied to the corresponding cross point in which the programmable resistor unit cell 510 is binary. The weight is applied to the corresponding cross point by the programmable resistor unit cell 510 when the synaptic resistor 520 is activated and the weight is not applied to the corresponding cross point by the programmable resistor unit cell 510 when the synaptic resistor is deactivated.

Rather than limit the weight applied to the corresponding cross point to being the fixed resistance value of the synaptic resistor 520 as well as being binary in that the weight is either applied or not, the programmable resistor bank configuration 600 may provide increased variability of the weight applied to the corresponding cross point in which the resistor bank 650 is positioned. The resistor bank 650 may include a plurality of resistor unit cells 610(a-n) positioned in parallel with each other. Each resistor unit cell 610(a-n) may be activated and/or deactivated thereby activating and/or deactivating the fixed resistance of the corresponding synaptic resistor 620(a-n). However, the activation and/or deactivation of each resistor unit cell 610(a-n) may be done in a combination such that the combination of fixed resistances that are activated and/or deactivated may be done in a manner to generate a combined weight that is then applied by the resistor bank 650. The combined weight from the combined fixed resistances of the activated resistor unit cells 610(a-n) may then be applied as a conductance to the input voltage at the cross point in which the resistor bank 650 is positioned to thereby influence the current that propagates down to the column output ultimately generating an output voltage.

As discussed above, each synaptic resistor 620(a-n) is a fixed resistor with a fixed resistance. However, the combination of the synaptic resistors 620(a-n) in parallel via the resistor unit cells 610(a-n) may enable the combination of the activated synaptic resistors 620(a-n) to combine into an overall resistance value of the resistor bank 650 that is variable. Although each synaptic resistor 620(a-n) has a fixed resistance value, the combination of activating and/or deactivating each synaptic resistor 620(a-n) thereby activating and/or deactivating the fixed resistance values generates an overall resistance value for the resistor bank 650 that is variable due to the different combinations of activated and/or deactivated fixed resistance values. For example, the synaptic resistor 620a may be activated thereby activating the fixed resistance value of the synaptic resistor 620a and the synaptic resistor 620b may be activated thereby activating the fixed resistance value of synaptic resistor 620b while the synaptic resistor 620n may be deactivated thereby deactivating the synaptic resistance value of synaptic resistor 620n. In such an example, the combined resistance of the resistor bank 650 is the combined fixed resistance value of the synaptic resistor 620a and the synaptic resistor 620b. The overall resistance value of the resistor bank 650 may then continue to be varied based on the different combinations of fixed resistances associated with each synaptic resistor 620(a-n) that is activated and/or deactivated.

The different combinations of fixed resistance values associated with each synaptic resistor 620(a-n) that is activated and/or deactivated thereby resulting in an overall resistance value of the resistor bank 650 that is variable results in an overall weight that is applied by the resistor bank 650 to the input voltage at the cross point that is also variable. As the combination of synaptic resistors 620(a-n) that are activated and/or deactivated resulting in the different combination of fixed resistances that are activated and/or deactivated triggering the overall resistance value of the resistor bank 650, the overall weight of the resistor bank 650 is also adjusted, accordingly. In doing so, the variable resistance of a combination of fixed synaptic resistors 620(a-n) with fixed resistance values is significantly increased.

For example, the resistor bank 650 may include four resistor unit cells 610(a-n) in which each of the four resistor unit cells 610(a-n) include four different synaptic resistors 620(a-n), each with four different fixed resistor values. Such a resistor bank 650 with four resistor unit cells 610(a-n) may then operate as a four bit variable resistor in which the resistor bank 650 may have sixteen different combinations of synaptic resistors 620(a-n) activated and/or deactivated resulting in sixteen different combinations of fixed resistance values that may be combined based on the activation and/or deactivation of the combination of synaptic resistors 620(a-n). The sixteen different combinations of fixed resistance values may result in sixteen different overall resistance values of the resistor bank which may then translate into sixteen different overall weights that may be applied by the resistor bank 650.

Thus, the resistor bank 650 may be incorporated into an analog neuromorphic configuration and positioned at each cross point of the analog neuromorphic configuration. The different combinations of synaptic resistors 620(a-n) included in the resistor bank 650 may then activated and/or deactivated thereby adjusting the overall resistance value of the resistance bank 650 resulting in adjusting the overall weight of the resistance bank 650. The adjusting of the overall weight may then be applied to the input voltage thereby generating a conductance to influence the current that then propagates to the column and ultimately is converted to an output voltage. The different combinations of synaptic resistors 620(a-n) may then be continuously adjusted to be activated and/or deactivated thereby continuously adjusting the overall resistance value of the resistor bank 650 resulting in continuously adjusting the overall weight of the resistor bank 650.

Such adjustment may enable the resistor bank 650 when in combination with numerous other resistor banks 650 to be iteratively trained. The combination of synaptic resistors 620(a-n) that may be activated and/or deactivated in each resistor bank 650 that may be continuously adjusted thereby resulting in the continuous adjustment of the overall weights applied by each resistor bank 650 may be determined such that the resulting output voltages from the currents influenced by the conductance generated by such combination of overall weights may ultimately result in the correct recognition by the neural network represented by the analog neuromorphic configuration. In an embodiment, the each resistor cell 610(a-n) may be positioned in series relative to each other rather than parallel and may operate in a similar manner as discussed above.

FIG. 6 depicts a more advanced unit cell circuit where multiple resistor switching devices 660(a-n) are placed in parallel to increase the programming resolution of the synapses. Depending on which switching devices 660(a-n) are closed, the total current summed on the column output wire may be adjusted. Thus, multibit weights can be stored in the hardware and programmed as needed. To achieve the desired operation, digital signals are required to program the memory device to a specific state. Memory devices 1, 2, . . . ,N may be different memory structures such as SRAMs, or they may each be part of the single memory unit developed using a chain of flip flops. In either case, a set of digital signals is used to turn on or off a set of selection devices, each controlling whether current is able to flow through a single resistor. A specific weight resistance can be programmed by turning on the right combination of switching devices 660(a-n) so that the parallel combination of resistance values within a unit cell creates an equivalent resistance equal to the desired value.

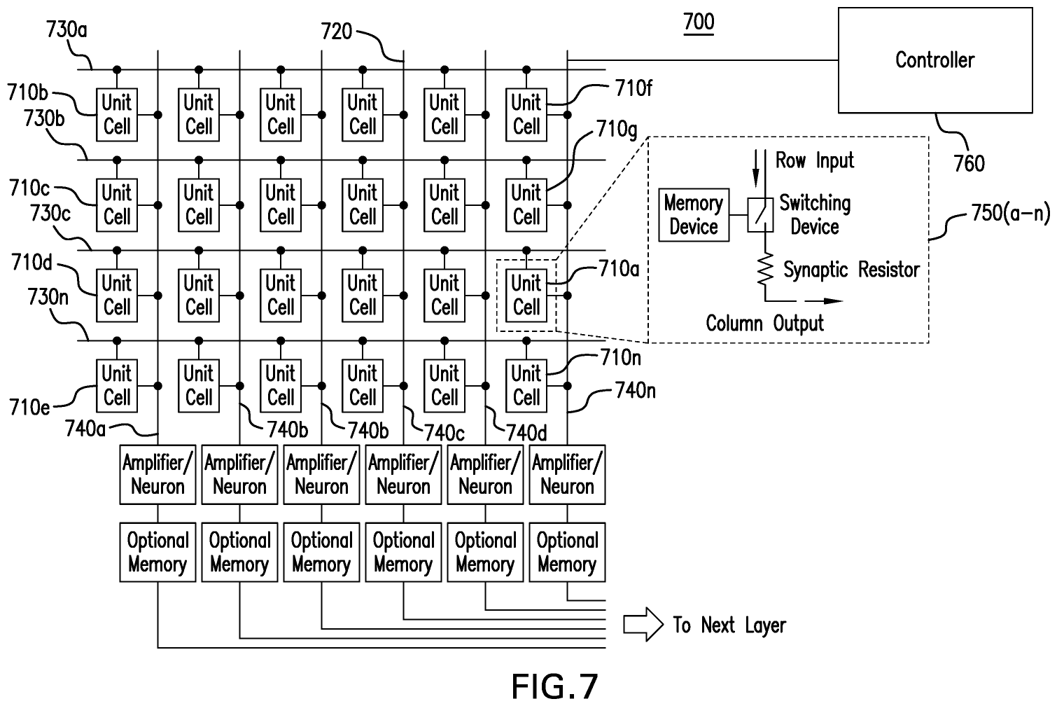

Referring to FIG. 7, in which like references are used to refer to like parts, a detailed analog neuromorphic configuration 700 is shown. The analog neuromorphic configuration 700 shares many similar features with the analog neuromorphic processing device 100, the analog neuromorphic circuit 200, the neural network configuration 300, and the analog neuromorphic configuration 400; therefore, only the differences between the analog neuromorphic configuration 700 and the analog neuromorphic processing device 100, the analog neuromorphic circuit 200, the analog neuromorphic configuration 300, and the analog neuromorphic configuration 400 are to be discussed in more detail.

The analog neuromorphic configuration 700 may include a plurality of resistive unit cells 710(a-n), where n is an integer equal to or greater than one and a controller 760. Each resistive unit cell 710(a-n) may be positioned at a cross point of the row (horizontal) wires and the column (vertical) wires that form a crossbar layer 720. The positioning of the resistive unit cell 710(a-n) at the cross point of a row and column of the crossbar layer 720 may generate a synaptic weight at the cross point of the row and column. As a result, a synaptic weight is formed at each cross point where a resistive unit cell 710(a-n) is present.

The analog neuromorphic configuration 700 may implement a resistor bank 750(a-n) to operate as a plurality of variable resistors. As shown in FIG. 7, each resistive unit cell 710(a-n) may include a resistor bank 750(a-n) as discussed in detail above with regard to FIG. 6. Rather than simply have a synaptic resistor that is activated and/or deactivated resulting in a binary weight generation for the corresponding cross point, the resistor bank 750(a-n) may act as a variable resistor thereby providing different combinations of fixed resistances that when combined into an overall resistance value of the resistor bank 750(a-n) results in a combined weight that is also variable. Thus, the variable resistance of each resistive unit cell 710(a-n) may result in variable weights that when applied to each cross point may enable such variable weights to be adjusted to obtain the desired functionality of the analog neuromorphic configuration 700.

A plurality of input voltages 730(a-n) may be applied to a plurality of inputs of the analog neuromorphic configuration 700. Each input voltage 730(a-n) may be applied to a horizontal wire of the analog neuromorphic configuration 700 in which each input voltage 730(a-n) may then be applied to each resistive unit cell 710(a-n) positioned on each corresponding horizontal wire.

A plurality of resistor banks 750(a-n) in which each resistor bank including a plurality of fixed resistors with each resistor bank may provide a variable resistance to each input voltage 730(a-n) applied to each of the inputs so that each input voltage 730(a-n) is multiplied in parallel by the corresponding variable resistance of each corresponding resistor bank 750(a-n) to generate a corresponding current for each input voltage 730(a-n) and each corresponding current is added in parallel. The variable resistance of each resistor bank 750(a-n) is based on an overall resistance value of the plurality of fixed resistors included in each resistor bank 750(a-n). As discussed above, the overall resistance value of the fixed resistors included in each resistor bank 750(a-n) may be applied to the corresponding input voltage 730(a-n) as a weight and thereby influence the corresponding current as each corresponding current propagates down to the corresponding column output 740(a-n) and is ultimately converted to a corresponding output voltage.

The controller 760 may adjust the variable resistance of each resistor bank 750(a-n) by adjusting the overall resistance value of the plurality of fixed resistors included in each resistor bank 750(a-n) to obtain a functionality of the analog neuromorphic configuration 700. The overall resistance value of each resistor bank 750(a-n) is generated from fixed resistance value of each fixed resistor relative to each other as included in each corresponding resistor bank 750(a-n). The controller 760 may execute the functionality of the analog neuromorphic configuration 700 that is generated from each of the input voltages 730(a-n) multiplied in parallel with each of the corresponding currents for each of the input voltages added in parallel and the adjusted variable resistance of each resistance bank 750(a-n). As discussed above, the overall resistance value of the fixed resistors included in each resistor bank 750(a-n) may be adjusted thereby adjusting the weight of the resistor bank 750(a-n) in which such an adjustment may result in the desired functionality of the analog neuromorphic configuration 700.

The controller 760 may activate each fixed resistor included in each corresponding resistor bank 750(a-n) to have each activated fixed resistor provide the fixed resistance value of each activated fixed resistor to the overall resistance value of the plurality of fixed resistors included in the corresponding resistor bank 750(a-n). Each fixed resistor generates the corresponding fixed resistance value when the corresponding fixed resistor is activated. The controller 760 may deactivate each fixed resistor include in each corresponding resistor bank 750(a-n) to have each deactivated fixed resistor remove the fixed resistance value of each deactivated fixed resistor from the overall resistance value of the plurality of fixed resistors included in the corresponding resistor bank 750(a-n). Each fixed resistor fails to generate the corresponding fixed resistance value when the corresponding fixed resistor is deactivated. As discussed above, the combination of fixed resistors may be activated to generate the overall resistance value of the resistor bank 750(a-n) in which the overall resistance value may be adjusted by adjusting the combination of fixed resistors that are activated and/or deactivated.

The controller 760 may close a switch of each fixed resistor as positioned in parallel in each corresponding resistor bank 750(a-n) to activate each corresponding fixed resistor associated with the closed switch to provide the fixed resistance value of each activated fixed resistor in parallel to the overall resistance value of the corresponding resistor bank 750(a-n). The overall resistance value of the corresponding resistor bank 750(a-n) is adjusted based on the fixed resistance values provided in parallel by each activated fixed resistor. The controller 760 may open a switch of each fixed resistor as positioned in parallel in each corresponding resistor bank 750(a-n) to deactivate each corresponding fixed resistor associated with the open switch to remove the fixed resistance value of each deactivated fixed resistor from the overall resistance value of the plurality of fixed resistors included in the corresponding resistor bank 750(a-n). The overall resistance value of the corresponding resistor bank 750(a-n) is adjusted based on the fixed resistance values removed from being provided in parallel by each deactivated fixed resistor.

The controller 760 may determine each fixed resistor included in each corresponding resistor bank 750(a-n) to activate each fixed resistor included in each corresponding resistor bank 750(a-n) to deactivate to adjust the overall resistance value of each corresponding resistor bank 750(a-n). The controller 760 may adjust the variable resistance of each resistor bank 750(a-n) based on the determined activation of each fixed resistor and the determined deactivation of each fixed resistor to adjust the overall resistance value of each corresponding resistor bank 750(a-n) thereby adjusting the variable resistance of each resistor bank 750(a-n) to obtain the functionality of analog neuromorphic configuration 700.

As discussed above, the controller 760 may adjust the combination of fixed resistors that are activated and/or deactivated in each resistor bank 750(a-n) to adjust the overall resistance of each resistor bank 750(a-n). In doing so, the controller 760 may adjust the weight applied by each resistor bank 750(a-n) which may then generate a corresponding conductance that influences the current that propagates down to the current output 740(a-n). Each current output 740(a-n) may then be converted into output voltage signals and such output voltage signals may represent the functionality and/or outcome of the analog neuromorphic configuration 700. The controller 760 may then easily adjust the overall resistances of the numerous resistor banks 750(a-n) in an iterative manner until each of the weights are tuned in a manner such that the corresponding conductance influences the current in a manner ultimately to the point where the output voltage signals represent the desired functionality and/or outcome. In doing so, the fixed resistors in the each resistor bank 750(a-n) may act as variable resistances enabling the controller 760 to adequately train the analog neuromorphic configuration 700.

The resolution of the analog neuromorphic configuration 700 may be scaled up and/or down in manner in which the quantity of fixed resistors included in each resistor bank 750(a-n) may be increased and/or decreased in a manner to increase and/or decrease the resolution of the analog neuromorphic configuration 700. As discussed above, the quantity of the fixed resistors included in each resistor bank configuration 750(a-n) may provide 2 to the N different combinations of overall resistance values. For example, four fixed resistors included in each resistor bank 750(a-n) may provide sixteen different combinations of fixed resistors being activated and/or deactivated resulting in sixteen different overall resistance values that resistor bank 750(a-n) may provide. If increased resolution is needed, five fixed resistors included in each resistor bank 750(a-n) may provide thirty-two different combinations of fixed resistors being activated and/or deactivated resulting in thirty-two different overall resistance values that resistor bank 750(a-n) may provide. If further increased resolution is needed, six different resistors included in each resistor bank 750(a-n) may provide sixty-four different combinations of fixed resistors being activated and/or deactivated resulting in sixty-four different overall resistance values that the resistor bank 750(a-n) may provide.

As a result, the quantity of fixed resistors in each resistor bank 750(a-n) may be increased and/or decreased depending on the application. There may be applications in which training may be too difficult simply with each resistor bank 750(a-n) being four bit and thus require eight bits or even sixteen bits to train. However, as the quantity of fixed resistors included in each resistor bank 750(a-n) increases, the overall size of the chip also increases. In doing so, applications that do not require such high resolution to train, may instead operate with each resistor bank 750(a-n) being four bit and reducing the size of the chip as the eight bit and sixteen bit resistor banks 750(a-n) are simply needed for such applications. Thus, the resistor bank configuration of analog neuromorphic configuration 700 may enable analog neuromorphic configuration 700 to operate in training which may require an increase in the size of resistor banks 750(a-n) but also in inference. Inference is where offline training is performed by an offline desktop training system rather than the analog neuromorphic configuration 700 itself such that the analog neuromorphic configuration 700 does not require that resistor banks 750(a-n) be increased to eight bits or sixteen bits but rather four bits may be sufficient for inference.

In FIG. 7, depicts how a crossbar layer 720 may be formed using the resistor unit cells 510, 550 in FIG. 5. As opposed to FIG. 4, there is a resistance unit cell 710(a-n) at every cross point. This is because the circuit FIG. 7 is programmable, so in any location where a zero needs to be programmed, all the unit cell resistor(s) will be switched off, so no current can flow at that synaptic weight location. Based on the unit cell design in FIG. 5, it is possible to have multiple resistance values all contributing to a single weight value. This is done to increase programming resolution.

The resolution of weights that can be programmed in this crossbar layer 720 is dependent on the complexity of the unit cell 710(a-n). For example, if four resistors (each with a corresponding activation switch and memory location) are used in each unit cell 710(a-n), then a 4 bit resolution (or 16 unique resistance values) can be programmed at each cross point. This corresponds to the number of possible switching combinations possible using 4 binary switches. While, resistance values within each unit cell can be set in any arbitrary pattern, according to the optimization of a neural network's performance, a pattern of X Ω, 2X Ω, 4X Ω, 8X Ω, . . . ,2^{N-1}X Ω with N resistors would result in the most uniform programmability. In other words, Synaptic Resistor 1 is set to X Ω, Synaptic Resistor 2 is set to 2X Ω, and Synaptic Resistor N is set to 2^{N-1}X Ω.

However, it is possible to set the unit cell resistances differently, if one would desire a logarithmic or 1/X pattern when selecting programmable resistance states. Furthermore, if a specific type of neural network required an unusual set of resistances based on where weights most commonly tended towards after a software training study, this could be accommodated as well by selecting a set of resistances for the unit cells that do not have an apparent pattern.

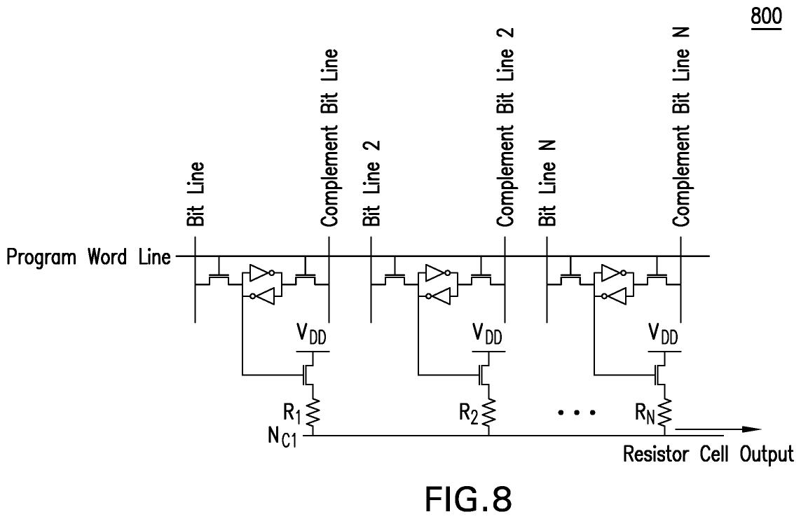

Referring to FIG. 8, in which like reference numerals are used to refer to like parts, a multi-bit programmable unit cell design configuration 800 is shown. The multi-bit programmable unit cell design configuration 800 is based on SRAM memory arrays. To present a specific embodiment, a circuit that produces a multibit unit cell with a pass transistor controlled by an SRAM cell is displayed in FIG. 8. In this embodiment, a digital memory controller may set the states of each SRAM cell to either 1 or 0. This may control which resistors in the unit cell are switched on, and thus the total parallel equivalent resistance at each cross point. This is an example where SRAM is used, and any type of memory device may be used in its place, such as a flash memory cell, an MRAM device, or an RRAM device (which could additionally be combined with the pass transistor). Furthermore, while this embodiment describes finding an equivalent parallel resistance to set the weight value, a similar setup with a series resistance measurement may also be used, where multiple resistors are combined in series to place varied weight values all in a linear path.

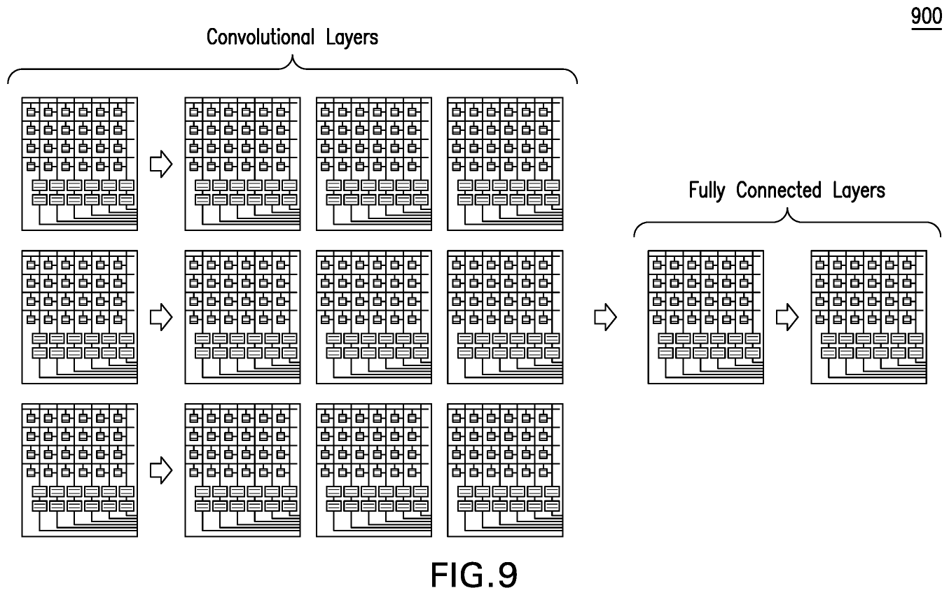

Referring to FIG. 9, in which like reference numerals are used to refer to like parts, an unit cell neural network configuration 900 is shown. The unit cell neural network configuration 900 may be an example of how multiple crossbar structures may be arranged to create a hardware neural network. FIG. 9 shows how multiple crossbars can be tied together to implement a convolutional neural network with extreme efficiency. In general, the proposed structure can be used to implement any number of neural networks including feed forward, single and multi-layer perceptrons, autoencoders, recurrent neural networks, or any others that are based on passing input data through layers of neurons connected through synaptic weight matrices. The proposed resistor-based crossbar structure acts as a component used to build up a single neural network layer. In the most basic cases, the proposed resistance crossbar can simply be used to implement a single layer in a feed forward network. However, if the single network layer is very large (maybe more than 40 inputs/outputs) multiple resistor crossbars may have to be stitched together to build the entire network layer.

Alternatively, convolutional neural networks require convolution layers in addition to feed forward layers. The convolution layers are implemented in a different manner with respect to input data ordering and weight reuse for a single input sample. Each convolution filter, or kernel, may be stored in a small resistive crossbar, and each filter can be processed in parallel using copies of the small crossbars each storing a different filter, or one larger crossbar with shared inputs. This operate in an operation mode where one output pixel of the convolution layer is generated each cycle, but all filters are processed in parallel in a single layer.

In an alternative embodiment, much larger crossbars can be arranged with many copies of the same convolution filter, so that an entire output feature map can be generated in a single cycle for a given convolution layer. This approach is faster but requires more resources especially in terms of area, and may be more susceptible to noise or device defects.

It is up to the system designer to determine which approach would be best for them. Either way, since the convolution operation is based on the repetition of a single dot product, there are ways one can easily apply the proposed resistive crossbar unit to carry out these operations. Furthermore, another operation common in CNNs, known as average pooling, can also be implemented using the proposed resistive crossbar unit. An averaging function may be a dot product where all elements in one of the input vectors equal the same value. This method is used to implement the averaging function, and thus the average pooling layer. Therefore, by connecting many of these resistive crossbar units within the same neural network design, each operation may be executed in a CNN in a high-speed parallel form using analog computation. FIG. 9 shows a basic diagram of how the proposed crossbar design could be arranged to implement a full operational programmable CNN using resistive computation.

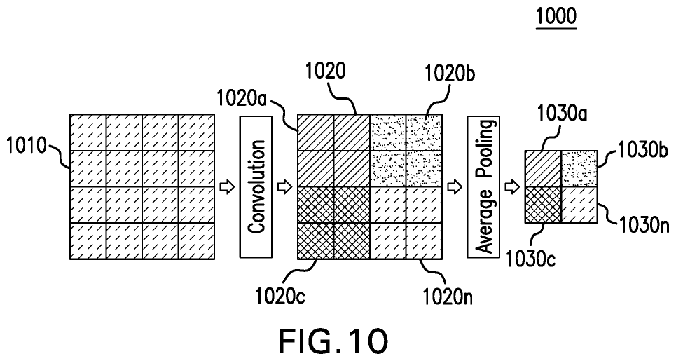

Referring to FIG. 10, in which like reference numerals are used to refer to like parts, an example neural network hardware architecture configuration 1000 is shown. Convolutional neural networks may get significantly large and the analog neuromorphic configuration 400 that incorporate the resistor bank configurations a variable resistors may execute such computations in hardware such that every computation is accounted for in physical space on the chip. Neural network hardware architecture configuration 700 may provide an implementation to reduce the memory required between each crossbar layer of the analog neuromorphic configuration 400 to shrink the physical space required on the chip for the convolutional neural network as implemented by the analog neuromorphic configuration 400.

The neural network hardware architecture configuration 1000 depicts how one of the layers in a convolutional neural network may be reduced. The output pixels 1010 may be a grid that is entering the convolution operation. The output of the output pixels 1010 after entering the convolution operation is a feature map 1020 with a convolution output in which the convolution output is divided into four sections of 1020a, 1020b, 1020c, and 1020n. In such an example the output pixels 1010 may be sixteen output pixels resulting from sixteen input pixels. In such an example, each of the sixteen input pixels may be applied as input voltages in the analog neuromorphic configuration 400 in FIG. 4 or the analog neuromorphic configuration 700 in FIG. 7. Each column of the analog neuromorphic configuration 400 or 700 may then be assigned to an output pixel. In such an example, the analog neuromorphic configuration 700 would then have sixteen input voltages via sixteen rows of the analog neuromorphic configuration 700 and then sixteen output voltages via sixteen columns of the analog neuromorphic configuration 700.

In such an example, the convolution filter may then be mapped within the overall resistance values of each of the resistor banks included in the analog neuromorphic configuration 700. Each of the sixteen crossbar columns may then take the filter values and have such filter values mapped to the correct row of the analog neuromorphic configuration 700. Each column is one instance of that filter and where the column is placed on the rows corresponds to the pixels that should contribute to that single output pixel thereby resulting in a 16x16 output pixel configuration and those sixteen output pixels may be stored in memory and may then be the output feature for convolution mapping.

Each of the four sections 1020a, 1020b, 1020c, and 1020n of the feature map 1020 of the convolution output may then enter a pooling layer in which an average pooling or max pooling operation may be executed on the feature map 1020 of the convolution output. In this example, the feature map 1020 of the convolution output may enter an average pooling operation but any pooling operation may be implemented. Each of the 4×4 sections 1020a, 1020b, 1020c, and 1020n of the feature map 1020 of the convolution output may then each be compressed into 2×2 blocks 1030a, 1030b, 1030c, and 1030n and into a single pixel. In this example, sixteen memory cells may be required at the output of the convolution layer and then another four memory cells at the output of the pooling layer.

Average pooling may then average the 1020a pixel outputs at the output of the convolution layer. Max pooling may take the maximum value of the four pixel outputs of the 1020a pixel outputs. Regardless, the pooling operation may map the 1020a pixel outputs to less pixel outputs. The same may be executed with the 1020b pixel outputs, the 1020c pixel outputs, and the 1020n pixel outputs. In doing so, sixteen columns may be coming out of the convolution layer in the feature map 1020 and then may be converted down to each of the four pixel outputs of 1020a, 1020b, 1020c, and 1020n thereby reducing memory in the convolution network.

The neural network hardware architecture configuration 700 may compute all necessary calculations in parallel and hold all data in the form of voltages and currents on the wire. For smaller networks, this is an extremely efficient design. The problem with this approach is that for larger networks, chip area constraints and the propagation of analog errors across long distances may be issues.

The neural network hardware architecture configuration 1000 may provide a method for minimizing the amount of memory required to store partial intermediate features in a convolutional neural network. The straightforward approach may be a design where each output feature is stored in memory after a layer computation is complete. FIG. 10 shows a diagram of how this process works for one convolution and pooling layer pair. The final 2 by 2 output of 1030a, 1030b, 1030c, and 1030n is generated as the final result in this diagram after one convolution and one subsampling layer process. This is the easiest system to visualize and implement, but could be optimized further with no loss in performance. Furthermore, without pipelining this design the number of computation cycles required to perform a classification would be equal to the total number of pixels (or data points within a vector) generated in all layers. If pipelining were implemented, the number of computation cycles required would be equal to the number of output pixels generated in the layer that generates the largest number.

The neural network hardware architecture configuration 1100 depicts how one of the layers in a convolutional neural network may be reduced. The neural network hardware architecture configuration 1100 may rearrange the convolution operation such that the reducing of two layers may be executed simultaneously in which the simply the output of the pooling layer may then be stored thereby reducing the amount of memory needed. In doing so, the output of the convolution layer is required to only be as big as the pooling layer as compared to as big as the output image would be as in the neural network hardware architecture configuration 1000 in FIG. 10.

The neural network hardware architecture configuration 1100 may be a literal hardware implementation in such an example the sixteen output pixels 1110 may be stored after the convolution operation in which the output pixels 1110 needed for the single pooling operation may be stored. Each output of the convolution operation may then be erased and the overwritten as such output may not be needed again after the pooling operation is completed. In such an example, the neural network hardware architecture configuration 1100 may initially have the sixteen output pixels 1110. Unlike the neural network hardware architecture configuration 1000 where the intermediate sixteen pixel outputs of pixel outputs 1020a, pixel outputs 1020b, pixel outputs 1020c, and pixel outputs 1020n, are continued to be used and may not be discarded, neural network hardware architecture configuration 1100 may not need such an intermediate operation as such pixel outputs 1120a, pixel outputs 1120b, pixel outputs 1120c, and pixel outputs 1120n may not be required after the average output is determined. After the average output is determined, the average output is what is propagated to the next layer and the pixel outputs 1120a, pixel outputs 1120b, pixel outputs 1120c, and pixel outputs 1120n are no longer required and may be discarded.

For example, the convolution layer may just execute the convolution of pixel outputs 1120b of the output pixels 1110. A single average pooling operation may then be executed just on the pixel outputs 1120b. After the single average pooling operation is completed on the pixel outputs 1120b to generate the average pooled output 1130b, the pixel outputs 1120b may then be erased. The single average pooling operation may then be executed on just the output pixel outputs 1120c. After the single average pooling operation is completed on the pixel outputs 1120c to generate the average pooled output 1130c, the pixel outputs 1120c may then be erased. The single average pooling operation may then be executed on just the output pixel outputs 1120n. after the single average pooling operation is completed on the pixel outputs 1120n to generate the average pooled output 1130n, the pixel outputs 1120n may then be erased. Instead of having to store total of 256×256 output pixels, a 2×2 output pixels may be stored.

The neural network hardware architecture configuration 1100 may implement digital memory between analog computations in resistive crossbar arrays. To ensure that the proposed circuits may operate correctly independent of network size, the neural network hardware architecture configuration 1100 may implement methods that implement machine learning algorithms, deep neural networks, and convolutional neural networks using memory arrays at intermediate points so that data can be processed serially and stored until the previous layer is finished processing.

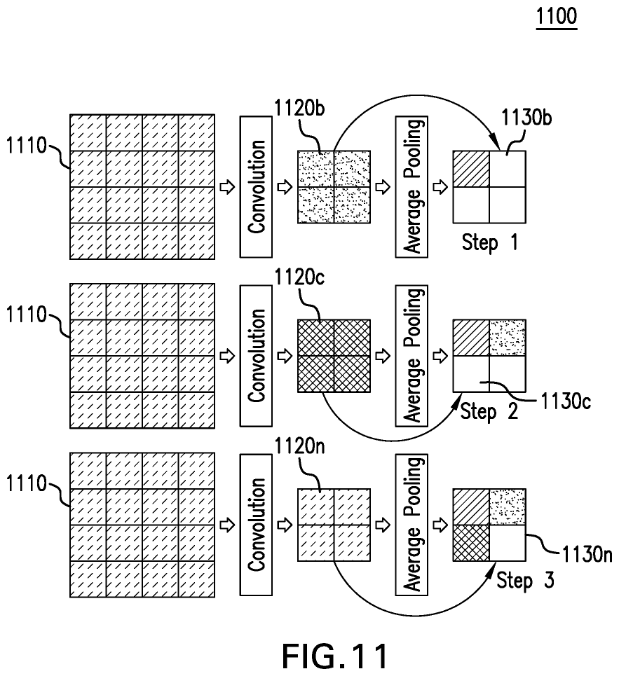

Typically, each convolution layer is followed by a pooling layer that is responsible for feature size reduction. In the case of a two-to-one subsampling, two-dimensional pooling layer, four output pixels from the convolution layer may be required to generate one single output pixel at the pooling output. Once this pixel at the pooling layer is generated, the four pixels generated at the previous convolution layer are no longer needed for future computations and can be overwritten. Thus, convolution output layer storage can be significantly reduced with no loss in accuracy or computation time. FIG. 11 shows a set of diagrams that describe how this process works. After the convolution layer, the small memory array only stores what is needed to generate a single pixel at the output of the pooling layer. At the final step, the output of the pooling layer in FIG. 11 may match that of FIG. 10.

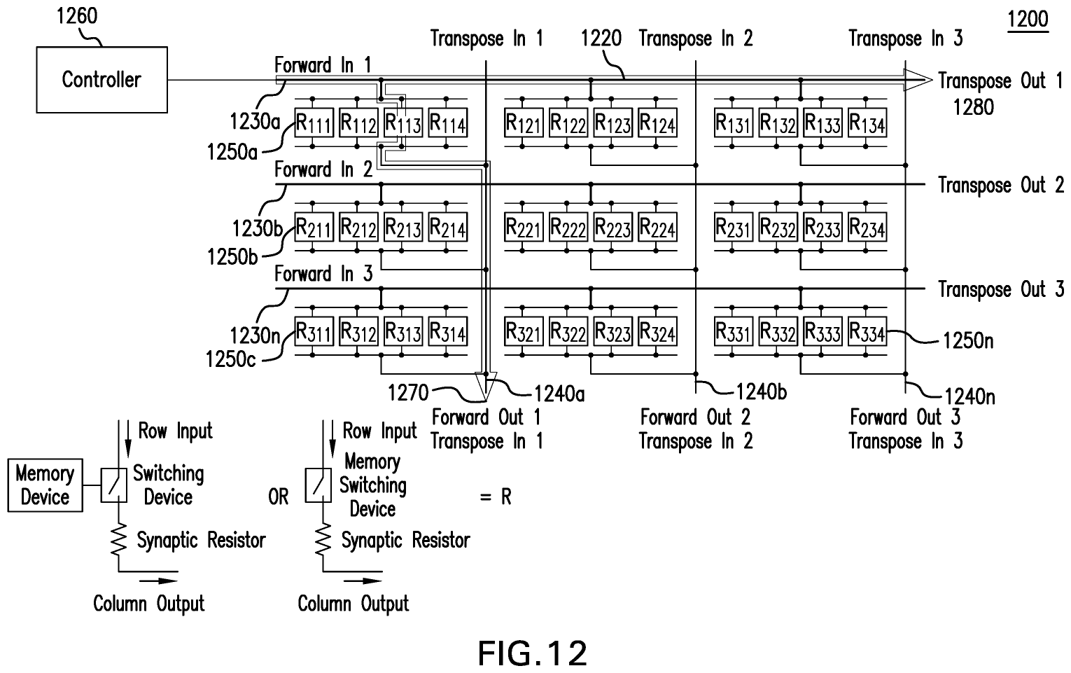

Referring to FIG. 12, in which like reference numerals are used to refer to like parts, a training analog neuromorphic configuration 1200 is shown. The training analog neuromorphic configuration 1200 share many similar features with the analog neuromorphic processing device 100, the analog neuromorphic circuit 200, the neural network configuration 300, the analog neuromorphic configuration 400, and the analog neuromorphic configuration 700; therefore, only the differences between the training analog neuromorphic configuration 1200 and the analog neuromorphic processing device 100, the analog neuromorphic circuit 200, the analog neuromorphic configuration 300, the analog neuromorphic configuration 400, and the analog neuromorphic configuration 700 are to be discussed in more detail.

The training analog neuromorphic analog configuration 1200 implement the resistor unit cells 610(a-n) as discussed in detail above with regard to FIG. 5 and FIG. 6 as well as implementing such resistor unit cells into resistor banks 650 as discussed in detail above with regard to FIG. 6. In doing so, the such resistor unit cells 610(a-n) may be trained in order to adjust the combination of fixed resistors that may be activated and/or deactivated to generate the overall resistance value of each resistor unit cell 610(a-n) to provide the appropriate overall weight in order for the analog neuromorphic analog configuration to obtain the requested functionality.

As shown in FIG. 12, the controller 1260 may apply each input voltage 1230(a-n) to each corresponding horizontal wire of the first crossbar configuration layer thereby triggering each input voltage 1230(a-n) to be applied to each resistor bank 1250(a-n) of the first crossbar configuration layer 1220 to generate a corresponding current 1240(a-n) for each input voltage 1230(a-n) that propagates along each corresponding vertical wire of the first crossbar configuration layer 1220. The controller 1260 may convert each corresponding current 1240(a-n) that propagates as an output of each corresponding vertical wire of the first crossbar configuration 1220 to a corresponding output voltage of the first crossbar configuration 1220. The propagation of each corresponding current 1240(a-n) triggered by each input voltage 1230(a-n) applied to each resistor bank 1250(a-n) of the first crossbar configuration 1220 may generate a forward pass 1270 of the input voltages 1230(a-n) applied to the resistor banks 1250(a-n) of the first crossbar configuration 1220. The forward pass 1270 is the initial propagation of the currents 1240(a-n) as generated from the input voltages 1230(a-n) applied to the weights of the resistor banks 1250 as provided by the overall resistance values of the resistor banks 1250.

The controller 1260 may apply each output voltage as converted from the corresponding current 1240(a-n) as each input voltage applied to a second crossbar configuration layer thereby triggering each input voltage of the second crossbar configuration layer to be applied to each resistor bank of the second crossbar configuration layer. The propagation of each corresponding current triggered by each input voltage applied to each resistor bank of the second crossbar configuration layer may generate the forward pass 1270 of the input voltages applied to the resistor banks of the second crossbar configuration layer. The training analog neuromorphic configuration 1200 may include several crossbar configuration layers in addition to the crossbar configuration layer 1220. The forward pass 1270 may then continue from the crossbar configuration layer 1220 to the second crossbar configuration layer which is the next crossbar configuration layer positioned in sequence from the first crossbar configuration layer 1220. The corresponding current 1240(a-n) as generated by the first configuration layer 1220 may then be converted to output voltages which may then be applied to the second crossbar configuration layer as input voltages thereby continuing the forward pass 1270 through the second crossbar configuration layer.

The controller 1260 may continue to apply each output voltage of each previous crossbar configuration layer as each input voltage to each subsequent configuration layer thereby triggering each input voltage of the subsequent crossbar configuration layer to be applied to each resistor bank of each subsequent configuration layer. The propagation of each corresponding current triggered by each input voltage applied to each resistor bank of the second crossbar configuration layer may generate the forward pass 1270 of input voltages applied to the resistor banks of each subsequent crossbar configuration layer. As mentioned above, the training analog neuromorphic configuration 1200 may include several crossbar configuration layers in addition to the crossbar configuration layer 1220. The forward pass 1270 may then continue from the crossbar configuration layer 1220 to each subsequent crossbar configuration layer which is the next crossbar configuration layer positioned in sequence from the previous crossbar configuration layer.

The controller 1260 may apply each output voltage of a last crossbar configuration layer of the forward pass 1270 as each input voltage to an immediate previous crossbar configuration layer of the forward pass 1270 thereby triggering each input voltage of the immediate previous crossbar configuration layer of the forward pass 1270 to be applied to each resistor bank of the immediate previous crossbar configuration layer. The last crossbar configuration layer is a last crossbar configuration layer that is immediately previous to the last crossbar configuration layer of the forward pass 1270. As mentioned above, the training analog neuromorphic configuration 1200 may include several crossbar configuration layers in addition to the crossbar configuration layer 1220. The forward pass 1270 may then continue until the forward pass reaches the immediate previous crossbar configuration which is immediately previous to the last crossbar configuration of the training analog neuromorphic configuration 1200. Once the forward pass 1270 reaches the last crossbar configuration layer of the training analog neuromorphic configuration 1200, the forward pass 1270 is completed.

The controller 1260 may then apply each output voltage of each immediate previous crossbar configuration layer as each input voltage to each subsequent immediate previous crossbar configuration layer thereby triggering each input voltage of the subsequent immediate previous crossbar configuration layer to be applied to each resistor bank of each subsequent immediate previous crossbar configuration layer. The propagation of each corresponding current triggered by each input voltage applied to each resistor bank of each subsequent immediate previous crossbar configuration layer generates a backward pass 1280 of the input voltages applied to the resistor banks of each subsequent immediate previous crossbar configuration layer that is opposite the forward pass 1270 thereby transposing the backward pass 1280 from the forward pass 1270.

After the forward pass 1270 is completed at the last crossbar configuration layer of the training analog neuromorphic configuration 1200, the controller 1260 may then automatically initiate the backward pass 1280. The controller 1260 may initiate the backward pass 1280 by applying the output voltages of the last crossbar configuration in the training analog neuromorphic configuration 1200 as generated in completing the forward pass 1270 to the immediate previous crossbar configuration as input voltages. The output voltages of the immediate previous crossbar configuration may then be applied as input voltages to the next crossbar configuration positioned in sequence above the immediate previous crossbar configuration. In doing so, the crossbar configuration which applied output voltages to as input voltages to the subsequent crossbar configuration which was next in sequence in the forward pass 1270 now reverses and receives the output voltages from the subsequent crossbar configuration as input voltages during the backward pass 1280. For example, the crossbar configuration 1220 applied the output voltages as input voltages to the second crossbar configuration during the forward pass 1270. The second crossbar configuration then applies the output voltages as input voltages to the crossbar configuration 1220 during the backward pass 1280 thereby completing the backward pass 1280. Thus, the backward pass 1280 is transposed from the forward pass 1270.

The controller 1260 may then compare the forward pass 1270 the backward pass 1280. In doing so, the controller 1260 may compare the output voltage of each crossbar configuration layer generated from each input voltage applied to each crossbar configuration of the forward pass to the each output voltage of each corresponding crossbar configuration layer generated from each input voltage to each corresponding layer of the backward pass. As discussed above, the backward pass 1280 is transposed from the forward pass 1270. For example, the second crossbar configuration layer had the output voltages generated from the crossbar configuration layer 1220 applied as input voltages in the forward pass 1270 and applied the output voltages of the second crossbar configuration layer to the subsequent crossbar configuration layer that is next in sequence as input voltages. The second crossbar configuration layer then the output voltages of the subsequent configuration layer that was next in sequence in the forward pass 1270 as applied as input voltages of the second crossbar configuration layer in the backward pass 1280 and the second crossbar configuration layer then applied the output voltages as input voltages to the crossbar configuration layer 1220 in the backward pass 1280.

As a result, each resistor bank of each crossbar configuration layer had input voltages applied to the resistor bank in the forward pass 1270 which was then transposed in the backward pass 1280. For example, the resistor bank of the second crossbar configuration layer had the output voltages generated from the crossbar configuration layer 1220 applied as input voltages to the resistor bank of the second crossbar configuration in the forward pass 1270. The resistor bank of the second crossbar configuration then had the output voltages generated from the subsequent configuration layer that was next in sequence in the forward pass 1270 applied as input voltages to the resistor bank of the second crossbar configuration in the backward pass 1280.

Thus, controller 1260 may compare the output voltages of each crossbar configuration layer as generated in the forward pass 1270 to the output voltages of the same crossbar configuration layer as generated in the backward pass 1280. For example, the controller 1260 may compare the output voltages of the second crossbar configuration as generated in the forward pass 1270 to the output voltages of the second crossbar configuration as generated in the backward pass 1280. The controller 1260 may then determine whether a difference between output voltage of each crossbar configuration layer of the forward pass 1270 exceeds the an output voltage threshold of each output voltage of each corresponding crossbar configuration layer of the backward pass. Each crossbar configuration layer of the forward pass is the same as each corresponding crossbar configuration layer of the backward pass.

The controller 1260 may then determine each fixed resistor included in each resistor bank of each crossbar configuration layer to activate and each fixed resistor included in each crossbar configuration layer to deactivate to adjust the overall resistance value of each corresponding resistor bank when the difference between each output voltage of each crossbar configuration layer of the forward pass 1270 exceeds the output voltage threshold of each output voltage of each corresponding crossbar configuration layer of the backward pass 1280. The controller 1260 may adjust the variable resistance of each resistor bank of each crossbar configuration layer based on the determined activation of each fixed resistor and the determined deactivation of each fixed resistor to adjust the overall resistance value of each corresponding resistor bank of each configuration layer when the output voltage of each crossbar configuration layer of the forward pass 1270 exceeds the output voltage threshold of each output voltage of each corresponding crossbar configuration layer of the backward pass to obtain the functionality of the training analog neuromorphic circuit 1200.

The output voltage of each crossbar configuration layer of the forward pass 1270 that exceeds the output voltage threshold of each corresponding crossbar configuration layer of the backward pass 1280 is indicative that the overall resistance values of the resistor banks require training. The desired functionality and/or outcome of the training analog neuromorphic configuration 1200 is not obtained when the output voltage of each crossbar configuration layer of the forward pass 1270 exceeds the output voltage threshold of each corresponding crossbar configuration layer of the backward pass 1280. As a result, the combination of fixed resistors in each resistor bank that is activated and/or deactivated may need to be updated so that the overall resistance value of the resistor bank is updated resulting in an updated weight.

Not only are the weight cells programmable, but the weights may updated weights according to learning rules so that neural network training can be performed on chip. This allows for extremely efficient classification, learning, and decision-making capabilities that can all be placed on our custom circuit, with no need for bulky external processing. FIG. 12 shows how the crossbar could be configured to provide a transposed processing of a weight matrix, a key processing step needed for online training (such as in the backpropagation step of training a CNN). Two possible memory and switching device options are shown in FIG. 12. The first option is a separate memory device and switching device, while in the second option, both devices are integrated into one device. An example of a memory device could be an SRAM cell, a Flash device, or an MRAM cell. Using an SRAM cell or a flip-flop for the memory device in may allow almost unlimited change in memory state. Using memristors or RRAM devices in the crossbar instead of fixed resistors makes the system smaller, but with limited amount of change in resistance state. As training can often involve a significant amount of weight changes during the training process, the approach with an SRAM or flip-flop as the memory device has the key advantage of being able to handle the large amount of memory state switching without adversely affecting the life of the devices (wear out of devices).

It is to be appreciated that the Detailed Description section, and not the Abstract section, is intended to be used to interpret the claims The Abstract section can set forth one or more, but not all exemplary embodiments, of the present disclosure, and thus, is not intended to limit the present disclosure and the appended claims in any way.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in art. The invention in its broader aspects is therefore not limited to the specific details, representative apparatus and method and illustrative examples shown and described. Accordingly, departures may be made from such details without departing from the scope of the general inventive concept.

What is claimed is:

1. An analog neuromorphic circuit that implements a resistor bank configuration to operate as a plurality of variable resistors, comprising:
a plurality of input voltages applied to a plurality of inputs of the analog neuromorphic circuit;
a plurality of resistor banks with each resistor bank including a plurality of fixed resistors with each resistor bank configured to provide a variable resistance to each input voltage applied to each of the inputs so that each input voltage is multiplied in parallel by the corresponding variable resistance of each corresponding resistor bank to generate a corresponding current for each input voltage and each corresponding current is added in parallel, wherein the variable resistance of each resistor bank is based on an overall resistance value of the plurality of fixed resistors included in each resistor bank; and
a controller configured to:
adjust the variable resistance of each resistor bank by adjusting the overall resistance value of the plurality of fixed resistors included in each resistor bank to obtain a functionality of the analog neuromorphic circuit, wherein the overall resistance value of each resistor bank is generated from a fixed resistance value of each fixed resistor relative to each other as included in each corresponding resistor bank, and
execute the functionality of the analog neuromorphic circuit that is generated from each of the input voltages multiplied in parallel with each of the corresponding currents for each of the input voltages added in parallel and the adjusted variable resistance of each resistor bank.

2. The analog neuromorphic circuit of claim 1, wherein the controller is further configured to:
activate each fixed resistor included in each corresponding resistor bank to have each activated fixed resistor provide the fixed resistance value of each activated fixed resistor to the overall resistance value of the plurality of fixed resistors included in the corresponding resistor bank, wherein each fixed resistor generates the corresponding fixed resistance value when the corresponding fixed resistor is activated; and
deactivate each fixed resistor included in each corresponding resistor bank to have each deactivated fixed resistor remove the fixed resistance value of each deactivated fixed resistor from the overall resistance value of the plurality of fixed resistors included in the corresponding resistor bank, wherein each fixed resistor fails to generate the corresponding fixed resistance value when the corresponding fixed resistor is deactivated.

3. The analog neuromorphic circuit of claim 2, wherein the controller is further configured to:
close a switch of each fixed resistor as positioned in parallel in each corresponding resistor bank to activate each corresponding fixed resistor associated with the closed switch to provide the fixed resistance value of each activated fixed resistor in parallel to the overall resistance value of the corresponding resistor bank, wherein the overall resistance value of the corresponding resistor bank is adjusted based on the fixed resistance values provided in parallel by each activated fixed resistor; and
open a switch of each fixed resistor as positioned in parallel in each corresponding resistor bank to deactivate each corresponding fixed resistor associated with the open switch to remove the fixed resistance value of each deactivated fixed resistor from the overall resistance value of the plurality of fixed resistors included in the corresponding resistor bank, wherein the overall resistance value of the corresponding resistor bank is adjusted based on the fixed resistance values removed from being provided in parallel by each deactivated fixed resistor.

4. The analog neuromorphic circuit of claim 3, wherein the controller is further configured to:
determine each fixed resistor included in each corresponding resistor bank to activate and each fixed resistor included in each corresponding resistor bank to deactivate to adjust the overall resistance value of each corresponding resistor bank; and
adjust the variable resistance of each resistor bank based on the determined activation of each fixed resistor and the determined deactivation of each fixed resistor to adjust the overall resistance value of each corresponding resistor bank thereby adjusting the variable resistance of each resistor bank to obtain the functionality of the analog neuromorphic circuit.

5. The analog neuromorphic circuit of claim 1, wherein each resistor bank is positioned at an intersection of a corresponding horizontal wire from a plurality of horizontal wires and a corresponding vertical wire from a plurality of vertical wires with each horizontal wire intersecting a corresponding vertical wire from the plurality of vertical wires to form a first crossbar configuration layer.

6. The analog neuromorphic circuit of claim 5, wherein the controller is further configured to:
apply each input voltage to each corresponding horizontal wire of the first crossbar configuration layer thereby triggering each input voltage to be applied to each resistor bank of the first crossbar configuration layer to generate a corresponding current for each input voltage that propagates along each corresponding vertical wire of the first crossbar configuration layer; and
convert each corresponding current that propagates as an output of each corresponding vertical wire of the first crossbar configuration to a corresponding output voltage of the first crossbar configuration, wherein the propagation of each corresponding current triggered by each input voltage applied to each resistor bank of the first crossbar configuration thereby generating corresponding output voltages of the first crossbar configuration generates a forward pass of the input voltages applied to the resistor banks of the first crossbar configuration.

7. The analog neuromorphic circuit of claim 6, wherein the controller is further configured to:
apply each output voltage of the first crossbar configuration layer as each input voltage applied to a second crossbar configuration layer thereby triggering each input voltage of the second crossbar configuration layer to be applied to each resistor bank of the second crossbar configuration layer, wherein the propagation of each corresponding current triggered by each input voltage applied to each resistor bank of the second crossbar configuration layer generates the forward pass of the input voltages applied to the resistor banks of the second cross bar configuration layer; and
continue to apply each output voltage of each previous crossbar configuration layer as each input voltage applied to each subsequent crossbar configuration layer thereby triggering each input voltage of the subsequent crossbar configuration layer to be applied to each resistor bank of each subsequent configuration layer, wherein the propagation of each corresponding current triggered by each input voltage applied to each resistor bank of the second crossbar configuration layer generates the forward pass of the input voltages applied to the resistor banks of each subsequent crossbar configuration layer.

8. The analog neuromorphic circuit of claim 7, wherein the controller is further configured to:
apply each output voltage of a last crossbar configuration layer of the forward pass as each input voltage to an immediate previous crossbar configuration layer of the forward pass thereby triggering each input voltage of the immediate previous crossbar configuration layer of the forward pass to be applied to each resistor bank of the immediate previous crossbar configuration layer, wherein the last crossbar configuration layer is a last crossbar configuration layer of the forward pass and the immediate previous crossbar configuration layer is a crossbar configuration that is immediately previous to the last crossbar configuration layer of the forward pass; and
continue to apply each output voltage of each immediate previous crossbar configuration layer as each input voltage applied to each subsequent immediate previous crossbar configuration layer thereby triggering each input voltage of the subsequent immediate previous crossbar configuration layer to be applied to each resistor bank of each subsequent immediate previous crossbar configuration layer, wherein the propagation of each corresponding current triggered by each input voltage applied to each resistor bank of each subsequent immediate previous crossbar configuration layer generates a backwards pass of the input voltages applied to the resistor banks of each subsequent immediate previous crossbar configuration layer that is opposite of the forward pass thereby transposing the backward pass from the forward pass.

9. The analog neuromorphic circuit of claim 8, wherein the controller is further configured to:
compare as generated from the forward pass each output voltage of each crossbar configuration layer generated from each input voltage applied to each crossbar configuration layer of the forward pass thereby triggering each input voltage applied to each crossbar configuration layer to be applied to each resistor bank of each crossbar configuration layer of the forward pass to as generated from the backward pass for each output voltage of each corresponding crossbar configuration layer generated from each input voltage to each corresponding configuration layer of the backward pass thereby triggering each input voltage applied to each corresponding crossbar configuration layer to be applied to each corresponding crossbar configuration of the backward pass; and
determine whether a difference between each output voltage of each crossbar configuration layer of the forward pass exceeds an output voltage threshold of each output voltage of each corresponding crossbar configuration layer of the backward pass, wherein each crossbar configuration layer of the forward pass is the same as each corresponding crossbar configuration layer of the backward pass.

10. The analog neuromorphic circuit of claim 9, wherein the controller is further configured to:
determine each fixed resistor included in each corresponding resistor bank of each crossbar configuration layer to activate and each fixed resistor included in each crossbar configuration layer to deactivate to adjust the overall resistance value of each corresponding resistor bank when the difference between each output voltage of each crossbar configuration layer of the forward pass exceeds the output voltage threshold of each output voltage of each corresponding crossbar configuration layer of the backward pass; and
adjust the variable resistance each resistor bank of each crossbar configuration layer based on the determined activation of each fixed resistor and the determined deactivation of each fixed resistor to adjust the overall resistance value of each corresponding resistor bank of each configuration layer when the output voltage of each crossbar configuration layer of the forward pass exceeds the output voltage threshold of each output voltage of each corresponding crossbar configuration layer of the backward pass to obtain the functionality of the analog neuromorphic circuit.

11. A method for implementing an analog neuromorphic circuit with a resistor bank configuration to operate as a plurality of variable resistors, comprising:
providing a variable resistance by a plurality of resistor banks with each resistor bank including a plurality of fixed resistors with each resistor bank providing a variable resistance to each input voltage applied to each of the inputs so that each input voltage is multiplied in parallel by the corresponding variable resistance of each corresponding resistor bank to generate a corresponding current for each input voltage and each corresponding current is added in parallel, wherein the variable resistance of each resistor bank is based on an overall resistance value of the plurality of fixed resistors included in each resistor bank;
adjusting by a controller the variable resistance of each resistor bank by adjusting the overall resistance value of the plurality of fixed resistors included in each resistor bank to obtain a functionality of the analog neuromorphic circuit, wherein the overall resistance value of each resistor bank is generated from a fixed resistance value of each fixed resistor relative to each other as included in each corresponding resistor bank; and
executing the functionality of the analog neuromorphic circuit that is generated from each of the input voltages multiplied in parallel with each of the corresponding currents for each of the input voltages is added in parallel and the adjusted variable resistance of each resistor bank.

12. The method of claim 11, wherein the adjusting comprises:
activating each fixed resistor included in each corresponding resistor bank to have each activated fixed resistor provide the fixed resistance value of each activated fixed resistor to the overall resistance value of the plurality of fixed resistors included in the corresponding resistor bank, wherein each fixed resistor generates the corresponding fixed resistance value when the corresponding fixed resistor is activated; and
deactivating each fixed resistor included in each corresponding resistor bank to have each deactivated fixed resistor remove the fixed resistance value of each deactivated fixed resistor from the overall resistance value of the plurality of fixed resistors included in the corresponding resistor bank, wherein each fixed resistor fails to generate the corresponding fixed resistance value when the corresponding fixed resistor is deactivated.

13. The method of claim 12, wherein the adjusting further comprises:
closing a switch of each fixed resistor as positioned in parallel in each corresponding resistor bank to activate each corresponding fixed resistor associated with the closed switch to provide the fixed resistance value of each activated fixed resistor in parallel to the overall resistance value of the corresponding resistor bank, wherein the overall resistance value of the corresponding resistor bank is adjusted on the fixed resistance values provided in parallel by each activated fixed resistor; and
opening a switch of each fixed resistor as positioned in parallel in each corresponding resistor bank to deactivate each corresponding fixed resistor associated with the open switch to remove the fixed resistance value of each deactivated fixed resistor from the overall resistance value of the plurality of fixed resistors included in the corresponding resistor bank, wherein the overall resistance value of the corresponding resistor bank is adjusted based on the fixed resistance values removed from being provided in parallel by each deactivated fixed resistor.

14. The method of claim 13, wherein the adjusting further comprises:
determining each fixed resistor included in each corresponding resistor bank to activate each fixed resistor included in each corresponding resistor bank to deactivate to adjust the overall resistance value of each corresponding resistor bank; and
adjusting the variable resistance value of each resistor bank based on the determined activation of each fixed resistor and the determined deactivation of each fixed resistor to adjust the overall resistance value of each corresponding resistor bank thereby adjusting the variable resistance of each resistor bank to obtain the functionality of the analog neuromorphic circuit.

15. The method of claim 11, further comprising:
positioning each resistor bank at an intersection of a corresponding horizontal wire from a plurality of horizontal wires and a corresponding vertical wire from a plurality of vertical wires with each horizontal wire intersecting a corresponding vertical wire from the plurality of vertical wires to form a first crossbar configuration layer.

16. The method of claim 15, further comprising:
applying each input voltage to each corresponding horizontal wire of the first crossbar configuration layer thereby triggering each input voltage to be applied to each resistor bank of the first crossbar configuration layer to generate a corresponding current for each input voltage that propagates along each corresponding vertical wire of the first crossbar configuration layer; and
converting each corresponding current that propagates as an output of each corresponding vertical wire of the first crossbar configuration to a corresponding output voltage of the first crossbar configuration, wherein the propagation of each corresponding current triggered by each input voltage applied to each resistor bank of the first crossbar configuration thereby generating corresponding output voltages of the first crossbar configuration generates a forward pass of the input voltages applied to the resistor banks of the first crossbar configuration.

17. The method of claim 16, further comprising:
applying each output voltage of the first crossbar configuration layer as each input voltage applied to a subsequent crossbar configuration layer thereby triggering each input voltage of the second crossbar configuration layer to be applied to each resistor bank of the second crossbar configuration layer, wherein the propagation of each corresponding current triggered by each input voltage applied to each resistor bank of the second crossbar configuration layer generates the forward pass of the input voltages applied to the resistor banks of the second crossbar configuration layer; and
continuing to apply each output voltage of each previous crossbar configuration layer as each input voltage applied to each subsequent crossbar configuration layer thereby triggering each input voltage of the subsequent crossbar configuration layer to be applied to each resistor bank of each subsequent configuration layer, wherein the propagation of each corresponding current triggered by each input voltage applied to each resistor bank of the second crossbar configuration layer generates the forward pass of the input voltages applied to the resistor banks of each second crossbar configuration layer.

18. The method of claim 17, further comprising:
applying each output voltage of a last crossbar configuration layer of the forward pass as each input voltage to an immediate previous crossbar configuration layer of the forward pass thereby triggering each input voltage of the immediate previous crossbar configuration layer of the forward pass to be applied to each resistor bank of the immediate previous crossbar configuration layer, wherein the last crossbar configuration layer is a last crossbar configuration of the forward pass and the immediate previous crossbar configuration layer is a crossbar configuration layer that is immediately previous to the last crossbar configuration layer of the forward pass; and
continuing to apply each output voltage of each immediate previous crossbar configuration layer as each input voltage applied to each subsequent immediate previous crossbar configuration layer thereby triggering each input voltage of the subsequent immediate previous crossbar configuration layer to be applied to each resistor bank of each subsequent immediate previous crossbar configuration layer, wherein the propagation of each corresponding current triggered by each input voltage applied to each resistor bank of each subsequent immediate previous crossbar configuration layer generates a backward pass of the input voltages applied to the resistor banks of each subsequent immediate previous crossbar configuration layer that is opposite the forward pass thereby transposing the backward pass from the forward pass.

19. The method of claim 18, further comprising:
comparing as generated from the forward pass each output voltage of each crossbar configuration layer generated from each input voltage applied to each crossbar configuration layer of the forward pass thereby triggering each input voltage applied to each crossbar configuration layer to be applied to each resistor bank of each crossbar configuration layer of the forward pass as generated from the backward pass of each output voltage of each corresponding crossbar configuration layer generated from each input voltage to each corresponding configuration layer of the backward pass thereby triggering each input voltage applied to each corresponding crossbar configuration layer to be applied to each corresponding crossbar configuration layer of the backward pass; and
determining whether a difference between each output voltage of each crossbar configuration layer of the forward pass exceeds an output voltage threshold of each output voltage of each corresponding crossbar configuration layer of the backward pass, wherein each crossbar configuration layer of the forward pass is the same as each corresponding crossbar configuration layer of the backward pass.

20. The method of claim 19, further comprising:
determining each fixed resistor included in each corresponding resistor bank of each crossbar configuration layer to activate and each fixed resistor included in each crossbar configuration layer to deactivate to adjust the overall resistance value of each corresponding resistor bank when the difference between each output voltage of each crossbar configuration layer of the forward pass exceeds the output voltage threshold of each output voltage of each corresponding crossbar configuration layer of the backward pass; and
adjusting the variable resistance of each resistor bank of each crossbar configuration layer based on the determined activation of each fixed resistor and the determined deactivation of each fixed resistor to adjust the overall resistance value of each corresponding resistor bank of each configuration layer when the output voltage of each crossbar configuration layer of the forward pass exceeds the output voltage threshold of each output voltage of each corresponding crossbar configuration layer of the backward pass to obtain the functionality of the analog neuromorphic circuit.
